(19) United States
(12) Patent Application Publication
(10) Pub. No.: US 2025/0321542 A1
(43) Pub. Date: Oct. 16, 2025

(54) ELECTRONIC DEVICE INCLUDING FASTENING STRUCTURE OF STRAP

(71) Applicant: Samsung Electronics Co., Ltd., Suwon-si (KR)

(72) Inventors: Jaechul LEE, Suwon-si (KR); Jaewoo kim, Suwon-si (KR); Juan LEE, Suwon-si (KR); Donggyu OH, Suwon-si (KR); Wookdam JUNG, Suwon-si (KR)

(21) Appl. No.: 19/247,270

(22) Filed: Jun. 24, 2025

Related U.S. Application Data
(63) Continuation of application No. PCT/KR2025/099600, filed on Mar. 6, 2025.

(30) Foreign Application Priority Data
Mar. 20, 2024 (KR) 10-2024-0038783
Jul. 16, 2024 (KR) 10-2024-0093597

(51) Int. Cl. G04G 17/02; G04B 37/14; G04G 17/08; G04G 21/02; G06F 1/16; G06F 3/01

(52) U.S. Cl. CPC G04G 17/02; G04B 37/1486; G04G 17/08; G04G 21/025; G06F 1/163; G06F 3/015

(57) ABSTRACT

An electronic device including a fastening structure of a strap of an embodiment is provided. The electronic device of an embodiment includes a housing 410 including a cavity portion 412 formed toward a side direction of the electronic device, a hook member 420-2 arranged within the cavity portion 412 and protruding toward the side direction of the electronic device, a button member 420-1 configured to move the hook member 420-2 toward a front direction of the electronic device by applying force to the hook member 420-2 toward the front direction of the electronic device, and a strap 450 fastened to the hook portion 524. The strap 450 includes a strap body 455, and a strap adapter 451 including an attachment portion 452 and a plurality of protrusion guides 453, and positioned at one side of the strap body 455 and fastened to the hook portion 524.

### CROSS-REFERENCE TO RELATED APPLICATIONS

This application is a continuation application of International Application No. PCT/KR2025/099600 designating the United States, filed on Mar. 6, 2025, at the Korean Intellectual Property Receiving Office and claiming priority to Korean Patent Application No. 10-2024-0038783 filed on Mar. 20, 2024 and Korean Patent Application No. 10-2024-0093597 filed on Jul. 16, 2024, at the Korean Intellectual Property Office, the disclosures of which are incorporated by reference herein in their entireties.

### BACKGROUND

### (1) Field

The disclosure relates to an electronic device including a fastening structure of a strap, and relates to a fastening structure capable of connecting a housing of the electronic device to a strap.

### (2) Description of the Related Art

An electronic device (e.g., a wearable/portable device in the form of a watch) can include a structure for fastening a strap to a housing by forming holes in four lugs provided in the housing and fastening a strap pin to the formed holes. For example, when the strap is fastened to the lug by using a spring bar-type pin, the strap including a unidirectional handle spring bar having a built-in spring can be fastened to the housing.

The above-described information can be provided as related art for the purpose of helping the understanding of the disclosure. No claim or determination is made as to whether any of the above-described contents is applicable as prior art in connection with the disclosure.

### SUMMARY

A wearable electronic device 100, 300, or 400 of an embodiment may include a housing 410 including a first side, a second side at least partially spaced from the first side and including a portion facing the first side, and a lateral side enclosing a space between the first side and the second side, where each of the first side and the second side protrudes outwardly with respect to the lateral side and forms a cavity portion 412, and a hook member 420-2 arranged in the cavity portion 412 and configured to reciprocally move between the first side and the second side in a first direction toward the first side and a second direction toward the second side. The hook member 420-2 may include an attachment portion 10, and an ending portion of the attachment portion 10 may protrude in the direction toward the first side or the second side.

An electronic device 100, 300, or 400 of an embodiment may include a housing 410 including a cavity portion 412 formed toward a side direction of the electronic device, a hook member 420-2 arranged within the cavity portion 412 and protruding toward the side direction of the electronic device, a button member 420-1 configured to move the hook member 420-2 toward a front direction of the electronic device by applying force to the hook member 420-2 toward the front direction of the electronic device, and a strap 450 fastened to the hook portion 524.

In addition, the strap 450 may include a strap body 455, and a strap adapter 451 including an attachment portion 452 and a plurality of protrusion guides 453, and positioned at one side of the strap body 455 and fastened to the hook portion 524.

In addition, the attachment portion 452 of the strap adapter 451 may be fastened to the hook member 420-2. The plurality of protrusion guides 453 of the strap adapter 451 may be inserted into a plurality of recesses 412-2 and 412-3 formed in the cavity portion 412 and prevent the movement of the strap 450 fastened to the housing 410.

An electronic device 100, 300, or 400 of an embodiment may include a housing 410 including a cavity portion 412 formed toward a side direction of the electronic device, a fastening member 520 including a hook portion 524 arranged within the cavity portion 412 and protruding toward the side direction of the electronic device and a button portion 522 extending from the hook portion 524 toward a rear direction of the electronic device, and a strap 450 including a strap body 455, and a strap adapter 451 positioned at one side of the strap body 455 and fastened to the hook portion 524.

In addition, the strap adapter 451 may include an attachment portion 452 and a plurality of protrusion guides 453. The attachment portion 452 of the strap adapter 451 may be fastened to the hook portion 524. The plurality of protrusion guides 453 of the strap adapter 451 may be inserted into a plurality of recesses 412-2 and 412-3 formed in the cavity portion 412 and prevent the movement of the strap 450 fastened to the housing 410.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a perspective view of a front face of an electronic device according to an embodiment.

FIG. 2 is a perspective view of a rear face of an electronic device according to an embodiment.

FIG. 3 is an exploded perspective view of an electronic device according to an embodiment.

FIG. 4 is an exploded perspective view of an electronic device for explaining an attachment structure of a housing and a strap of an electronic device according to an embodiment.

FIG. 5 is an exploded perspective view of an electronic device for explaining an attachment structure of a housing and a strap of an electronic device according to an embodiment.

FIG. 6 is a diagram illustrating an example in which a button member and a hook member are arranged in a cavity portion of a housing according to an embodiment.

FIG. 7A is a sectional view illustrating a section A-A′ of FIG. 6 according to an embodiment.

FIG. 7B is a sectional view illustrating a section A-A′ of FIG. 6 according to an embodiment.

FIGS. 7C, 7D, 7E and 7F are diagrams illustrating an example in which a fastening member is assembled to a housing according to an embodiment.

FIG. 8A is a diagram for explaining a plate spring arranged between a fastening member and a cavity portion according to an embodiment.

FIG. 8B is a diagram for explaining a plate spring arranged between a fastening member and a cavity portion according to an embodiment.

FIG. 9 is a sectional view illustrating a section B-B′ of FIG. 6 according to an embodiment.

FIGS. 10A and 10B are diagrams illustrating an attachment portion protruding from a strap adapter of a strap according to an embodiment.

FIG. 10C is a diagram illustrating an attachment portion not protruding from a strap adapter of a strap according to an embodiment.

FIG. 10D is a diagram for explaining an example of an attachment portion and a protrusion guide formed in a strap according to an embodiment.

FIGS. 11A and 11B are diagrams illustrating an example in which a hook member is attached to an attachment portion of a strap according to an embodiment.

FIG. 12A is a diagram illustrating the arrangement of a button member when looking at an electronic device from a rear face of an electronic device according to an embodiment.

FIG. 12B is a sectional view illustrating a section C-C′ of FIG. 12A according to an embodiment.

FIG. 13A is a diagram illustrating a strap attached to a housing when looking at a side direction of an electronic device according to an embodiment.

FIG. 13B is a sectional view illustrating a section D-D′ of FIG. 13A according to an embodiment.

FIG. 14A is a diagram for explaining a recess formed in a strap according to an embodiment.

FIG. 14B is a diagram for explaining a cavity portion in which a protrusion guide is formed according to an embodiment.

FIG. 14C is a sectional view illustrating a section E-E′ of FIG. 14B according to an embodiment.

FIG. 15A is a diagram illustrating a protrusion formed on a strap according to an embodiment.

FIG. 15B is a sectional view illustrating a portion of a section F-F′ of FIG. 15A in a state in which a strap is attached to a housing according to an embodiment.

FIG. 16 is a diagram for explaining a body magnet arranged in a housing and a strap magnet arranged in a strap according to an embodiment.

FIG. 17 is a sectional view illustrating a section G-G′ of FIG. 16 according to an embodiment.

FIG. 18A is a diagram illustrating an example of a body magnet and a strap magnet arranged in an electronic device according to an embodiment.

FIG. 18B is a diagram illustrating an example of a body magnet and a strap magnet arranged in an electronic device according to an embodiment.

FIG. 19A is a diagram illustrating an example in which a strap magnet is arranged in a strap adapter according to an embodiment.

FIG. 19B is a diagram illustrating an example in which a strap magnet is arranged in a strap adapter according to an embodiment.

FIG. 19C is a diagram illustrating an example in which a strap magnet is arranged in a strap adapter according to an embodiment.

FIG. 20 is a diagram for explaining the arrangement of a body magnet and a strap magnet according to an embodiment.

FIGS. 21A and 21B are diagrams illustrating an integrally formed fastening member according to an embodiment.

FIG. 22 is a diagram illustrating an example of a recess formed in a lateral wall of a cavity portion according to an embodiment.

FIG. 23 is a diagram illustrating an example of a locking member according to an embodiment.

FIG. 24 is a diagram illustrating an example of a locking member arranged in a seating portion formed in a lateral wall of a cavity portion according to an embodiment.

FIG. 25 is a diagram illustrating an example in which an integral fastening member is inserted into a cavity portion where a locking member is arranged according to an embodiment.

FIG. 26A is a diagram for explaining a process in which an integral fastening member is inserted into a cavity portion where a locking member is arranged according to an embodiment.

FIG. 26B is a diagram for explaining a process in which an integral fastening member is inserted into a cavity portion where a locking member is arranged according to an embodiment.

FIG. 26C is a diagram for explaining a process in which an integral fastening member is inserted into a cavity portion where a locking member is arranged according to an embodiment.

FIG. 27A is a diagram for explaining a process in which a strap is attached to a fastening member according to an embodiment.

FIG. 27B is a diagram for explaining a process in which a strap is attached to a fastening member according to an embodiment.

FIG. 27C is a diagram for explaining a process in which a strap is attached to a fastening member according to an embodiment.

FIG. 28A is a diagram for explaining an air pocket formed in a strap according to an embodiment.

FIG. 28B is a sectional view illustrating a section H-H′ of FIG. 28A according to an embodiment.

FIGS. 29A, 29B and 29C are diagrams illustrating a back plate and a biometric sensor module disposed on a rear face of an electronic device according to an embodiment.

FIG. 29D is a diagram illustrating a curvature of a first portion of a back plate of an electronic device according to an embodiment.

FIGS. 29E and 29F are diagrams for explaining a back plate protruding with a predetermined curvature from a rear face of an electronic device according to an embodiment.

FIG. 29G is a diagram illustrating an example in which an adherence force applied to the human body by the electronic device and a stability of the electronic device are ensured by a back plate of an electronic device having a curvature according to an embodiment.

FIG. 29H is a diagram for explaining a deviation of biometric signals measured multiple times by an electronic device including a back plate having a curvature according to an embodiment.

FIG. 30 is a block diagram of an electronic device in a network environment according to various embodiments.

### DETAILED DESCRIPTION

Embodiments are described below in detail with reference to the accompanying drawings so that they may be easily implemented by those skilled in the art to which the content of the disclosure pertains. However, the disclosed embodiments may be implemented in various different forms, and they are not limited to the embodiments described herein.

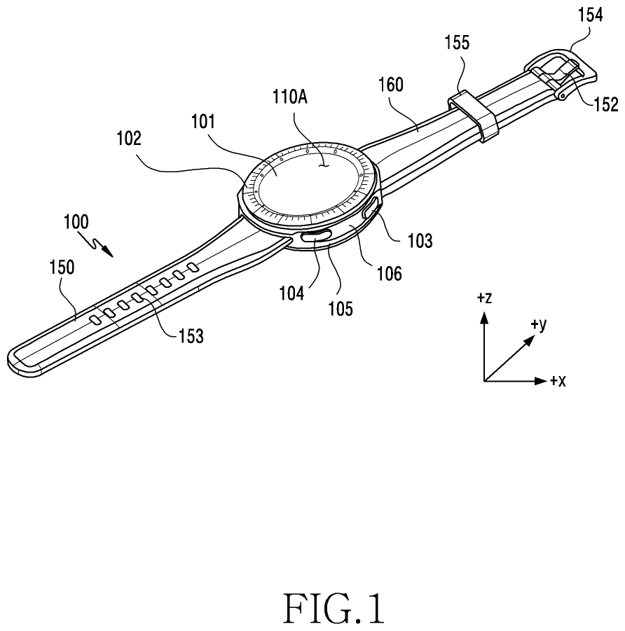

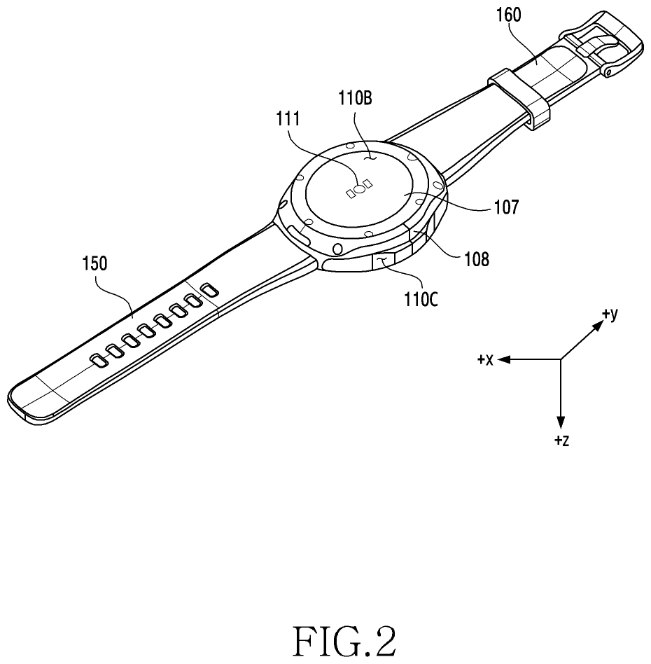

FIG. 1 is a perspective view of a front face of an electronic device according to an embodiment, and FIG. 2 is a perspective view of a rear face of the electronic device according to an embodiment.

Referring to FIGS. 1 and 2, the electronic device 100 of an embodiment may include a housing 110 including a first face (or front face) 110A, a second face (or back face) 110B, and a side face 110C surrounding a space between the first face 110A and the second face 110B, and attachment members 150 and 160 connected to at least a portion of the housing 110 and configured to detachably attach the electronic device 100 to a portion of the user's human body (e.g., wrist, ankle, etc.). According to an embodiment (not shown), the housing 110 may also refer to a structure forming a portion of the first face 110A, the second face 110B, and the side face 110C of FIG. 1. In an embodiment, the first face 110A may be formed by a front plate 101 that is at least partially substantially transparent (e.g., a glass plate including various coating layers, or a polymer plate). The second face 110B may be formed by a substantially opaque back plate 107. The back plate 107 may be formed by, for example, coated or colored glass, ceramic, polymer, metal (e.g., aluminum, stainless steel (STS), or magnesium), or a combination of at least two of the above-described materials. The side face 110C may be formed by a side bezel structure (or “side member”) 106 that is coupled to the front plate 101 and the back plate 107 and includes metal and/or polymer. In some embodiment, the back plate 107 and the side bezel structure 106 may be formed integrally and include the same material (e.g., metal material such as aluminum). The attachment members 150 and 160 may be formed of various materials and shapes. An integral and plurality of unit links of the attachment members 150 and 160 may be formed to be mutually movable by woven fabric, leather, rubber, urethane, metal, ceramic, or a combination of at least two of the above-described materials.

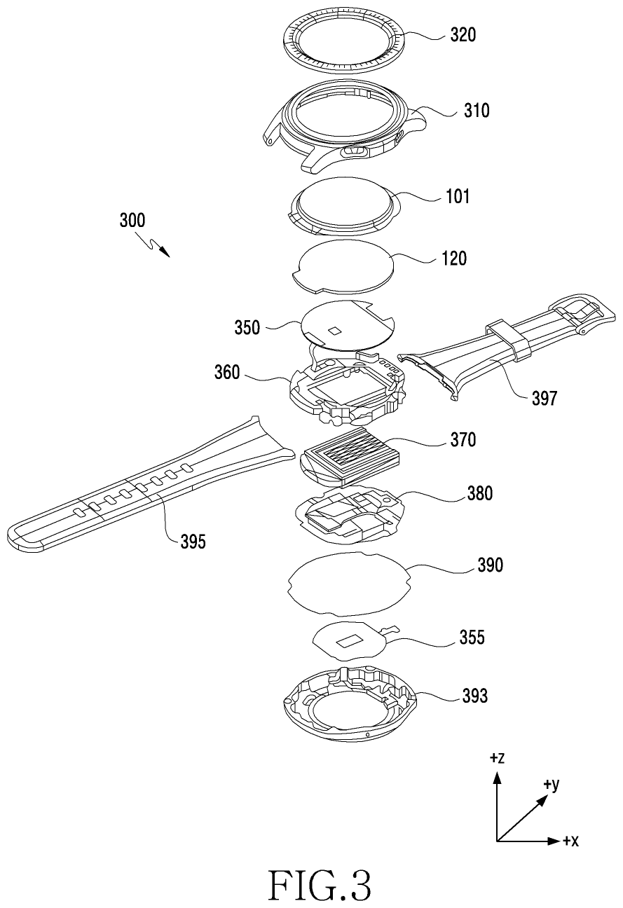

According to an embodiment, the electronic device 100 may include at least one of a display 120 (see FIG. 3), audio modules 105 and 108, a sensor module 111, key input devices 102, 103, and 104, and a connector hole 109. In some embodiment, the electronic device 100 may omit at least one of the components (e.g., key input devices 102, 103, and 104, connector hole 109, or sensor module 111) or may additionally include other components.

The display 120 may be exposed, for example, through a significant portion of the front plate 101. The shape of the display 120 may include a shape corresponding to the shape of the front plate 101, and may include various shapes such as a circular shape, an oval shape, or a polygonal shape. The display 120 may be coupled to or arranged adjacent to a touch detection circuit, a pressure sensor capable of measuring the intensity (pressure) of a touch, and/or a fingerprint sensor.

The audio modules 105 and 108 may include a microphone hole 105 and a speaker hole 108. A microphone for acquiring external sound may be arranged inside the microphone hole 105, and in some embodiment, a plurality of microphones may be arranged and detect the direction of the sound. The speaker hole 108 may be used as a receiver for an external speaker and calls. In some embodiment, the speaker hole 108 and the microphone hole 105 may be implemented as one hole, or a speaker (e.g., piezo speaker) may be included without the speaker hole 108.

The sensor module 111 may provide an electric signal or data value corresponding to an internal operating state of the electronic device 100 or an external environmental state. The sensor module 111 may include, for example, a biometric sensor module 111 (e.g., HRM sensor) disposed on the second face 110B of the housing 110. The electronic device 100 may further include at least one of a sensor module (not shown), for example, a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, or an illuminance sensor.

The key input devices 102, 103, and 104 may include a wheel key 102 disposed on the first face 110A of the housing 110 and rotatable in at least one direction, and/or side key buttons 103 and 104 disposed on the side face 110C of the housing 110. The wheel key 102 may have a shape corresponding to the shape of the front plate 101. According to an embodiment, the electronic device 100 may not include some or all of the above-mentioned key input devices 102, 103, and 104, and the key input devices 102, 103, 104 not included may be implemented in other forms, such as soft keys, on the display 120.

The attachment members 150 and 160 may be detachably attached to at least a portion of the housing 110. The attachment members 150 and 160 may include one or more of a fixing member 152, a fixing member fastening hole 153, a band guide member 154, and a band fixing ring 155.

The fixing member 152 may be configured to fix the housing 110 and the attachment members 150 and 160 to a portion (e.g., a wrist, an ankle, etc.) of the user's human body. The fixing member fastening hole 153 may correspond to the fixing member 152 and fix the housing 110 and the attachment members 150 and 160 to a portion of the user's human body. The band guide member 154 may be configured to limit the range of movement of the fixing member 152 when the fixing member 152 is fastened to the fixing member fastening hole 153, and allow the attachment members 150 and 160 to be fastened in close contact with a portion of the user's human body. The band fixing ring 155 may limit the range of movement of the attachment members 150 and 160 in a state where the fixing member 152 is fastened to the fixing member fastening hole 153.

FIG. 3 is an exploded perspective view of an electronic device according to an embodiment.

Referring to FIG. 3, an electronic device 300 may include a side bezel structure 310, a wheel key 320, a front plate 101, a display 120, a first antenna 350, a second antenna 355, a support member 360 (e.g., bracket), a battery 370, a printed circuit board 380, a sealing member 390, a back plate 393, and attachment members 395 and 397. At least one of the components of the electronic device 300 may be identical to or similar to at least one of the components of the electronic device 100 of FIG. 1 or FIG. 2, and a repeated description is omitted below. The support member 360 may be arranged inside the electronic device 300 and connected to the side bezel structure 310, or may be formed integrally with the side bezel structure 310. The support member 360 may be formed of, for example, a metal material and/or a non-metallic (e.g., polymer) material. The support member 360 may be coupled at one side to the display 120 and be coupled at the other side to the printed circuit board 380. The printed circuit board 380 may be equipped with a processor, a memory, and/or an interface. The processor may include, for example, one or more of a central processing unit, an application processor, a graphic processing unit (GPU), a sensor processor, or a communication processor.

The memory may include, for example, a volatile memory or a non-volatile memory. The interface may include, for example, a high-definition multimedia interface (HDMI), a universal serial bus (USB) interface, an SD card interface, and/or an audio interface. The interface may, for example, electrically or physically connect the electronic device 300 to an external electronic device, and may include a USB connector, an SD card/MMC connector, or an audio connector.

The battery 370, which is a device for supplying power to at least one component of the electronic device 300, may include, for example, a non-rechargeable primary battery, a rechargeable secondary battery, or a fuel cell. At least a portion of the battery 370 may be disposed substantially on the same plane as, for example, the printed circuit board 380. The battery 370 may be integrally arranged within the electronic device 100, and may also be detachably arranged within the electronic device 100.

The first antenna 350 may be arranged between the display 120 and the support member 360. The first antenna 350 may include, for example, a near field communication (NFC) antenna, a wireless charging antenna, and/or a magnetic secure transmission (MST) antenna. The first antenna 350 may, for example, perform short-range communication with an external device, or wirelessly transmit and receive power required for charging, and transmit a short-range communication signal or a magnetic-based signal including payment data. According to an embodiment, the antenna structure may be formed by a part of the side bezel structure 310 and/or the support member 360 or a combination thereof.

The second antenna 355 may be arranged between the printed circuit board 380 and the back plate 393. The second antenna 355 may include, for example, a near field communication (NFC) antenna, a wireless charging antenna, and/or a magnetic secure transmission (MST) antenna. The second antenna 355 may, for example, perform short-range communication with an external device, or wirelessly transmit and receive power required for charging, and transmit a short-range communication signal or a magnetic-based signal including payment data. According to an embodiment, the antenna structure may be formed by a part of the side bezel structure 310 and/or the back plate 393 or a combination thereof.

The sealing member 390 may be located between the side bezel structure 310 and the back plate 393. The sealing member 390 may be configured to block or reduce moisture and foreign substances inserted into a space surrounded by the side bezel structure 310 and the back plate 393 from the outside.

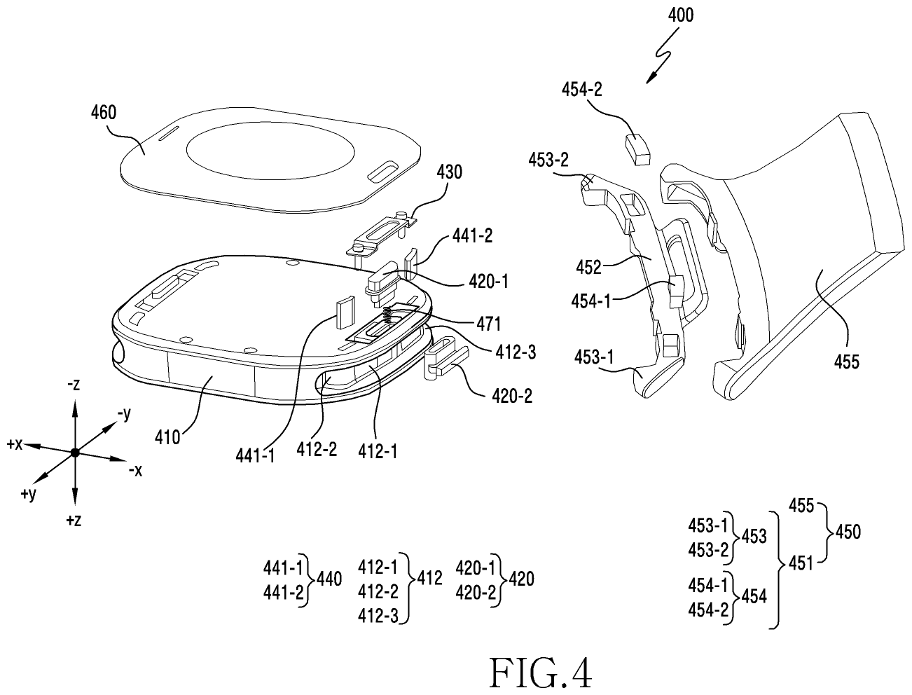

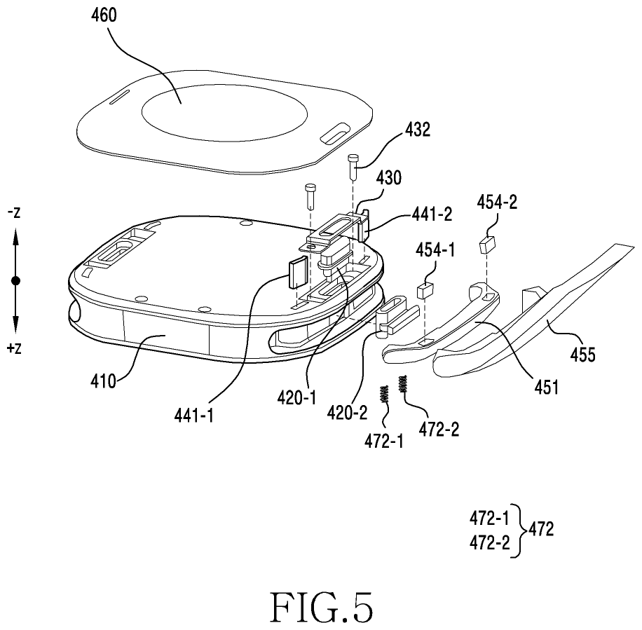

FIG. 4 is an exploded perspective view of an electronic device for explaining an attachment structure of a housing and a strap of the electronic device according to an embodiment. FIG. 5 is an exploded perspective view of the electronic device for explaining the attachment structure of the housing and the strap of the electronic device according to an embodiment.

The electronic device 400 of FIGS. 4 and 5 may correspond to the electronic device 100 of FIGS. 1 and 2 and the electronic device 300 of FIG. 3.

Referring to FIGS. 4 and 5, the electronic device 400 may include a housing 410, a fastening member 420, a bracket 430, at least one body magnet 440, a strap 450, and a back plate 460. At least one of the components of the electronic device 400 may be identical or similar to at least one of the components of the electronic device 100 of FIG. 1 and FIG. 2 and the electronic device 300 of FIG. 3, and a repeated description is omitted below.

According to an embodiment, the housing 410 may include a cavity portion 412 formed open toward a side direction of the electronic device 400. The cavity portion 412 may include a lateral wall 412-1 and a plurality of recesses 412-2 and 412-3 formed in the lateral wall 412-1.

Referring to FIG. 4, for example, the lateral wall 412-1 of the housing 410 may be defined extended substantially along the y and z directions and define an outer surface of the housing 410 which is exposed to outside the housing 410 by the cavity (e.g., the cavity portion 412). The first side and the second side of the housing 410 may be disposed in a plane extended in directions crossing each other, such as the x direction and the y direction which cross each other (i.e., an xy plane), where each of the x and y directions crosses the z direction. The z direction may be considered a thickness direction of the electronic device 400 and various components thereof.

In an embodiment, the housing 410 includes a lateral side (e.g., the lateral wall 412-1), a first side wall which protrudes further than the lateral side (i.e., an upper plate-shaped portion in the xy plane and disposed in the-z direction), and a second side wall which protrudes further than the lateral side (i.e., a lower plate-shaped portion in the xy plane and disposed in the +z direction) at least partially spaced from the first side portion (e.g., along the z direction), where protruded portions of the first and second side walls together with the lateral side define or enclose a space (i.e., the cavity portion 412). Referring to FIG. 4, for example, the cavity portion 412-1 may be open to outside the housing 410 in the +x direction, the-y direction and the +y direction.

According to an embodiment, the fastening member 420 may include a button member 420-1 and a hook member 420-2. The hook member 420-2 may be arranged within the cavity portion 412 and may be attached to the strap 450 inserted into the cavity portion 412. The button member 420-1 may be coupled with the hook member 420-2, and may move the hook member 420-2 toward a front direction (e.g., +z direction) of the electronic device 400 by applying force to the hook member 420-2 toward the front direction of the electronic device 400.

According to an embodiment, a first spring 471 may be arranged between the hook member 420-2 and the button member 420-1. The first spring 471 arranged between the hook member 420-2 and the button member 420-1 may apply an elastic force to the hook member 420-2 and the button member 420-1 that are coupled to each other. According to an embodiment, the first spring 471 may be omitted. According to an embodiment, a second spring 472 may be arranged between the hook member 420-2 and the cavity portion 412. The second spring 472 may apply elastic force to the hook member 420-2 arranged in the cavity portion 412. The first spring 471 and/or the second spring 472 may include, for example, a coil spring and/or a plate spring, but are not limited thereto.

A structure for attachment between the strap 450 and the housing 410 described later such as the hook member 420-2 and the button member 420-1 may be located in an edge space of a main body of the electronic device 400 and reduce the size of a space required for attachment between the housing 410 and the strap 450. The main body may be defined by the housing together with the fastening member, and may have overall dimensions in each of thickness and planar directions. When the button member, etc. is arranged in the strap, the thickness of the strap may increase and the flexibility of the strap may decrease, so the convenience of use of the electronic device 400 may be reduced when the electronic device 400 is worn by a user. In contrast, when a mechanical structure such as the button member 420-1 of an embodiment is arranged within the electronic device 400 having a predetermined thickness, the usability and aesthetic elegance of the electronic device 400 may be secured.

In addition, since a hooking structure of the hook member 420-2 of an embodiment may be formed where a predetermined length of the hooking structure is secured along an edge of a main body of the electronic device 400 within the cavity portion 412, when the hook member 420-2 is attached to the strap 450, the area of a portion to which a force for fastening between the hook member 420-2 and the strap 450 is applied may increase. In addition, since the force for fastening between the hook member 420-2 and the strap 450 may be applied to a wider area toward a front direction (e.g., +z direction) or rear direction (e.g., −z direction) of the electronic device 400 which is opposite to the front direction, the strap 450 may be more stably fastened to the housing 410.

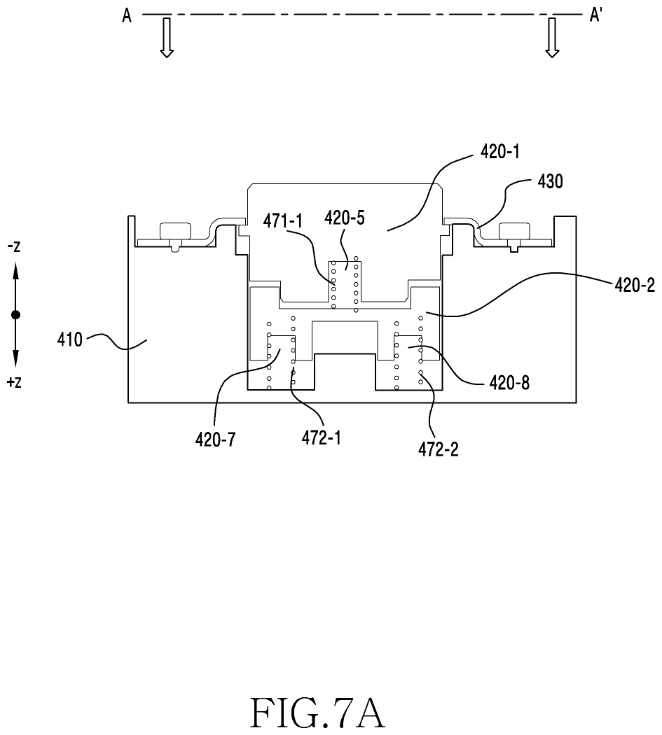

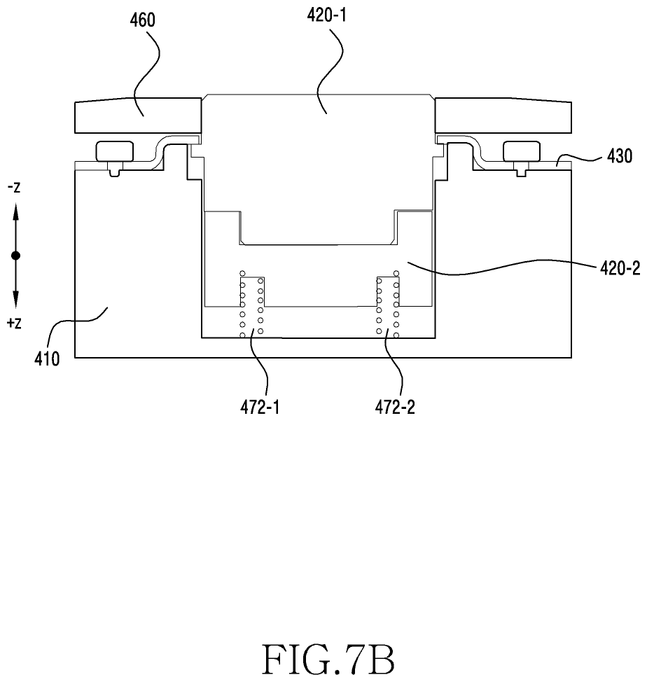

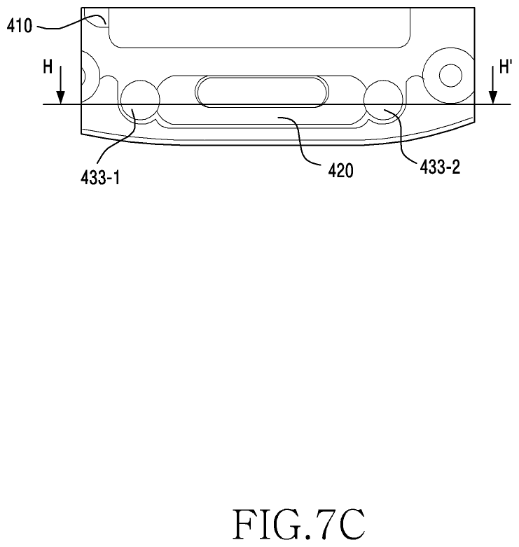

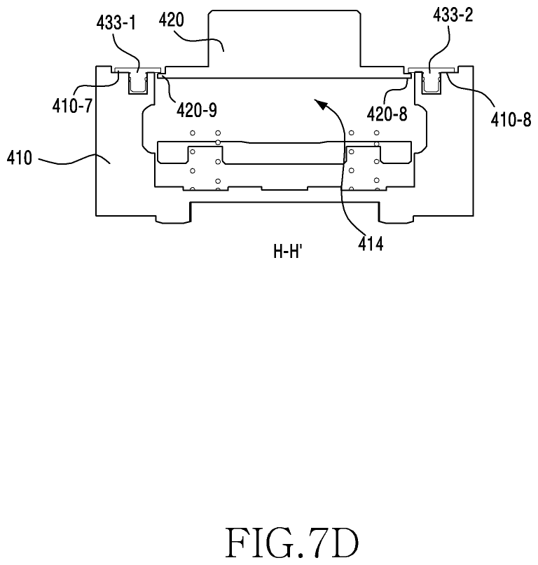

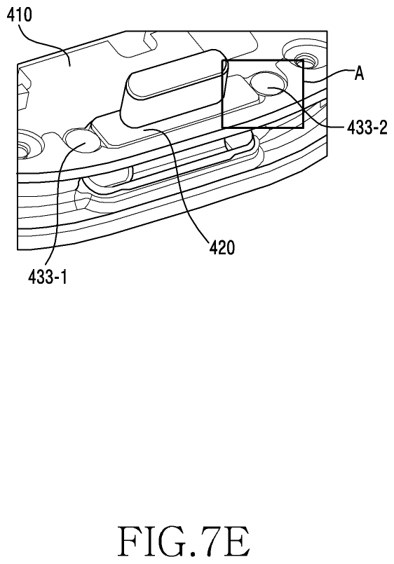

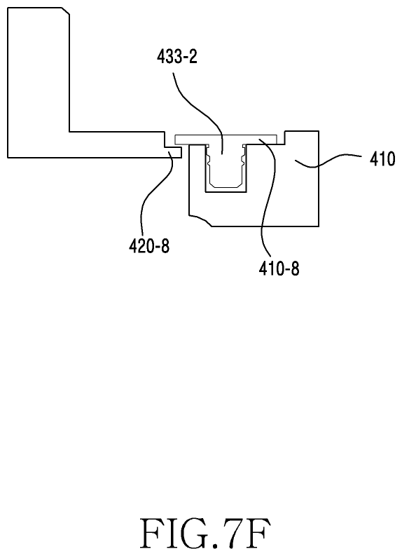

According to an embodiment, the bracket 430 may fix the button member 420-1 to the housing 410 where the fastening member 420 is not separated from the housing 410. The bracket 430 may be fixed to the housing 410 by a screw 432. According to an embodiment, the electronic device 400 may not include the bracket 430. For example, as in FIGS. 7C TO 7F, the electronic device 400 may be assembled to the housing 410 without the bracket 430.

According to an embodiment, at least one body magnet 440 may be arranged in the housing 410, and may be arranged at a position corresponding to at least one strap magnet 454 to be described later when the strap 450 is fastened to the housing 410. Accordingly, for example, when the strap 450 is fastened to the housing 410, an attractive force may be applied between the at least one body magnet 440 and the at least one strap magnet 454. When the attractive force is applied between the at least one body magnet 440 and the at least one strap magnet 454, the user may conveniently fasten the strap 450 to the housing 410. Or, for example, when the strap 450 is fastened to the housing 410, a repulsive force may be also applied between the at least one body magnet 440 and the at least one strap magnet 454. When the repulsive force is applied between the at least one body magnet 440 and the at least one strap magnet 454, the user may conveniently separate the strap 450 from the housing 410.

According to an embodiment, the magnets 440 having a plurality of polarities may be arranged in the housing 410, and may be arranged at positions corresponding to the plurality of strap magnets 454 to be described later when the strap 450 is fastened to the housing 410. In this case, the magnets 440 and the strap magnets 454 may be arranged where the magnets having different polarities are arranged at positions corresponding to each other. For example, the magnets 440 may be arranged in the order of N pole, S pole, and N pole, and the strap magnets 454 corresponding to the magnets 440 may be arranged in the order of S pole, N pole, and S pole. Accordingly, when the strap 450 is inserted into the housing 410 in a correct direction, an attractive force may be applied between the magnets 440 and the strap magnets 454, and when the strap 450 is inserted into the housing 410 in a wrong direction, a repulsive force may be applied between the magnets 440 and the strap magnets 454. In the above, it has been described that a plurality of magnets 440 having a plurality of polarities and a plurality of strap magnets 454 having a plurality of polarities are arranged, but are not limited thereto. For example, one magnet 440 having a plurality of polarities and one strap magnet 454 having a plurality of polarities may also be arranged.

According to an embodiment, the strap 450 may include a strap body 455, a strap adapter 451 as a strap connector, and at least one strap magnet 454. The strap 450 may correspond to the attachment members 150 and 160 of FIGS. 1 and 2 and the attachment members 395 and 397 of FIG. 3.

According to an embodiment, the strap body 455 may be connected to the strap adapter 451, and may be fastened to the housing 410 by the strap adapter 451. According to an embodiment, the strap adapter 451 may be arranged at one side of the strap body 455, and may be fastened to the hook member 420-2 of the housing 410. The strap adapter 451 may include an attachment portion 452 and a plurality of protrusion guides 453.

According to an embodiment, the strap adapter 451 may have a shape corresponding to the cavity portion 412 of the housing 410, and when the strap 450 is fastened to the housing 410, at least a portion of the strap adapter 451 may be surrounded by the cavity portion 412 of the housing 410. For example, when the strap 450 is fastened to the housing 410, an edge portion of the strap adapter 451 may be surrounded by the cavity portion 412 of the housing 410.

According to an embodiment, the strap 450 including the strap body 455 and the strap adapter 451 may be manufactured by injection molding using the strap adapter 451. For example, the strap 450 may be formed by forming the strap adapter 451 of a metal material and injection molding the strap adapter 451 by using a rubber material. However, the material of the strap body 455 is not limited to a rubber material. For example, the strap 450 may be manufactured by forming the strap adapter 451 on the strap body 455 of a fabric material through bonding and pressing. For example, the strap 450 in which the strap body 455 and the strap adapter 451 are integrally formed may also be manufactured.

According to an embodiment, the attachment portion 452 (e.g., coupling portion) of the strap adapter 451 at which the strap 450 is attached to the housing 410, may be formed in a hooking structure, and be attached to the hook member 420-2 of the housing 410 when a portion of the strap 450 is inserted into the cavity portion 412 of the housing 410.

According to an embodiment, the plurality of protrusion guides 453 of the strap adapter 451 may be inserted into the plurality of recesses 412-2 and 412-3 formed in the cavity portion 412 of the housing 410, and prevent the strap 450 from moving in the cavity portion 412 of the housing 410 after the strap 450 is fastened to the housing 410.

According to an embodiment, at least one strap magnet 454 may be arranged in the strap adapter 451, and may be arranged at a position corresponding to at least one body magnet 440 when the strap 450 is fastened to the housing 410. Accordingly, when the strap 450 is fastened to the housing 410, an attractive force may be applied between the at least one body magnet 440 and the at least one strap magnet 454.

Meanwhile, in FIG. 4, it is described that the electronic device 400 includes the at least one body magnet 440 and the at least one strap magnet 454, but is not limited thereto. For example, the electronic device 400 may not include the at least one body magnet 440 and the at least one strap magnet 454.

The back plate 460 of an embodiment may be arranged to cover one face at the first side facing the rear direction (e.g., −z direction) of the electronic device 400. For example, the back plate 460 may be formed to include a hole (i.e., an enclosed opening or an enclosed through-hole) surrounding the button member 420-1 and exposing a portion of the button member 420-1 to the outside of the electronic device 400. The enclosed opening may be open at both upper and lower surfaces of the back plate 460. The enclosed opening may correspond to an enclosed opening in the first side portion of the housing 410, such that the two enclosed openings may be aligned with each other to allow a hook-and-button structure to be connected at the aligned openings.

The housing 410 of the electronic device 400 of an embodiment may not include a separate lug for fastening the strap 450, and the strap 450 may be easily fastened to and separated from the housing 410.

A fastening structure of the housing 410 and the strap 450 of the electronic device 400 of an embodiment may improve the efficiency of a space in which components may be arranged within the electronic device 400.

The fastening structure of the housing 410 and the strap 450 of the electronic device 400 of an embodiment may be implemented in various designs, and the convenience of the user may be enhanced when the strap 450 is replaced.

The fastening structure of the housing 410 and the strap 450 of the electronic device 400 of an embodiment may be implemented with various materials and designs. For example, since the strap 450 may be fastened to the housing 410 including no lug, the housing 410 of the electronic device 400 may be formed in various shapes (e.g., cushion shape, polygonal shape, rectangular shape, etc.) other than a circular shape.

The fastening structure of the housing 410 and the strap 450 of the electronic device 400 of an embodiment may be manufactured with a high yield, and a cost required for manufacturing may be reduced. For example, since the strap 450 has a simple structure in which a complex driver is removed, a manufacturing yield is improved when the strap 450 is molded, and there is an effect of reducing the number of backup molds for short-term mass production and reducing a mold cost for manufacturing the housing 410 and the strap 450.

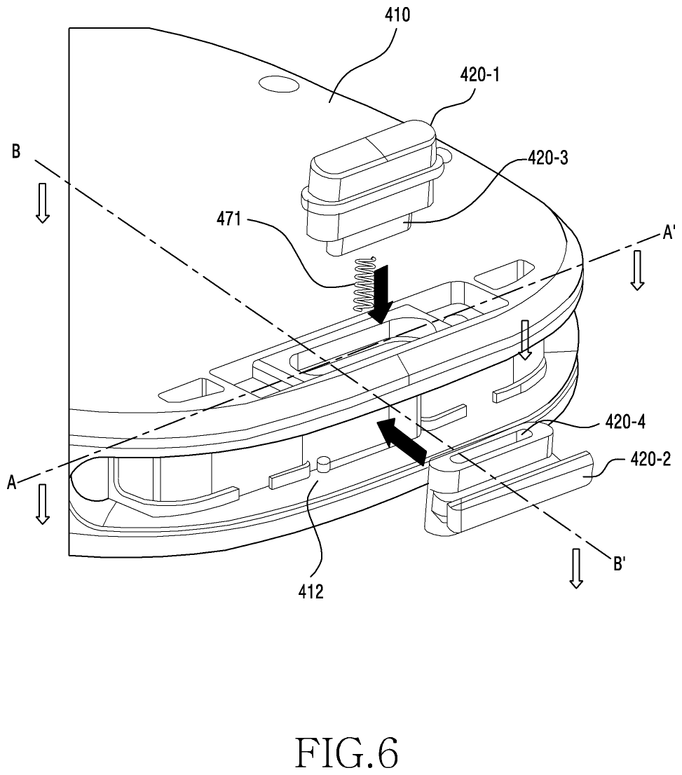

FIG. 6 is a diagram illustrating an example in which a button member and a hook member are arranged in a cavity portion of a housing according to an embodiment.

Referring to FIG. 6, the fastening member 420 of an embodiment may be arranged at least partially in the cavity portion 412 of the housing 410 by coupling the button member 420-1 with the hook member 420-2. The fastening member 420 coupled to the housing 410 may be exposed to outside the housing 410 at the cavity portion 412 which is open in the x direction to outside the housing 410.

According to an embodiment, the button member 420-1 may be inserted into the cavity portion 412 of the housing 410 through an opening 414 formed in (or by portions of) the housing 410 toward the rear direction (e.g., −z direction) of the electronic device 400 (e.g., open toward the rear direction). According to an embodiment, the hook member 420-2 may be arranged in a lower portion of the opening 414 in the cavity portion 412. According to an embodiment, a second spring (not shown) may be arranged between the hook member 420-2 and the cavity portion 412.

According to an embodiment, the button member 420-1 inserted into the cavity portion 412 through the opening 414 may be coupled with the hook member 420-2 arranged in the cavity portion 412. For example, the button member 420-1 may be assembled with the hook member 420-2 by inserting a protrusion portion 420-3 of the button member 420-1 into a groove portion 420-4 of the hook member 420-2. For example, a first spring 471 may be arranged between the button member 420-1 and the hook member 420-2, but is not limited thereto.

According to an embodiment, the fastening member 420 may be composed of the button member 420-1 and the hook member 420-2. The button member 420-1 may be inserted into the cavity portion 412 through the opening 414, and the hook member 420-2 may be arranged in the cavity portion 412 in a side direction of the electronic device 400. Accordingly, even if a space (or volume) of the cavity portion 412 is formed small, the fastening member 420 may be effectively arranged in the housing 410. The button member 420-1 may extend from outside of the housing 410, at the rear side thereof, and extend into the housing 410 at the cavity, via the opening 414. That is, the opening 414 may be open at about the rear side and the front side of a protruding (plate) portion of the housing 410.

FIG. 7A is a sectional view (e.g., cross-sectional view) illustrating a section A-A′ of FIG. 6 according to an embodiment.

Referring to FIG. 7A, the button member 420-1 may be coupled to the hook member 420-2 within the cavity portion of the housing 410. In this case, for example, a first spring 471-1 may be arranged between the button member 420-1 and the hook member 420-2. The first spring 471-1 may be arranged within a groove 420-5 (e.g., a spring groove) formed in the button member 420-1 and open in the front direction. The first spring 471-1 may provide a force between the button member 420-1 and the hook member 420-2, in opposing directions along the thickness direction, to bias the button member 420-1 and the hook member 420-2 in directions away from each other.

In addition, for example, second springs 472-1 and 472-2 may be arranged between the hook member 420-2 and the housing 410. The second springs 472-1 and 472-2 may be arranged within grooves 420-7 and 420-8 formed in the button member 420-1. These grooves may be open in the front direction. The second springs 472-1 and 472-2 may provide a force between the housing 410 and the hook member 420-2, in opposing directions along the thickness direction, to bias the housing 410 and the hook member 420-2 in directions away from each other.

Accordingly, for example, when the button member 420-1 is pressed by an outside force, like from a user, a repulsive force due to the elastic force of the first spring 471-1 and the second springs 472-1 and 472-2 may be applied to the user.

According to an embodiment, when the first spring 471-1 and the second springs 472-1 and 472-2 are arranged in two stages, a phenomenon may be prevented in which the strap 450 is separated from the housing 410 due to the button member 420-1 being unintentionally pressed. In addition, even when the button member 420-1 is pressed to a certain extent, the first spring 471-1 may absorb a certain force, and prevent a phenomenon in which the hook member 420-2 moves immediately.

FIG. 7B is a sectional view illustrating a section A-A′ of FIG. 6 according to an embodiment.

Referring to FIG. 7B, for example, the first spring 471-1 may be omitted. For example, the button member 420-1 may be coupled to the hook member 420-2 without the first spring 471-1. In addition, when a user presses the button member 420-1, a repulsive force due to the elastic force of the second springs 472-1 and 472-2 may be applied to the user.

Accordingly, when the strap 450 is mounted on the housing 410, a phenomenon may be prevented in which the strap 450 is tilted with respect to the housing 410 by at least one of the first spring 471-1 or the second springs 472-1 and 472-2.

FIGS. 7C to 7F are diagrams illustrating an example in which a fastening member is assembled to a housing according to an embodiment. FIG. 7F is an enlarged view of region A in FIG. 7E.

Referring to FIGS. 7C TO 7F, the fastening member 420 may be fixed to the housing 410 without a separate bracket 430. According to an embodiment, the fastening member 420 inserted into the opening 414 may be fixed to the housing 410, by a plurality of fasteners 433-1 and 433-2 inserted into a thickness portion of the housing and covering a partial region of a periphery of the housing body at the opening 414 and together with part of an edge of the fastening member 420. For example, ending portions 420-9 and 420-8 of an outer edge, which is adjacent to an opening, of a button portion (e.g., button member 420-1) of the fastening member 420 may be formed at a lower height along the thickness direction than other portions of the edge of the button portion of the fastening member 420. Such end portions may have a stepped shape.

In addition, recessed portions 410-7 and 410-8 may be formed as recesses of the housing 410 at positions, which are adjacent to the ending portions 420-9 and 420-8 of the fastening member 420, of the periphery of the opening 414 of the housing 410. In addition, the plurality of fasteners 433-1 and 433-2 may be extended into and fitted into the housing 410 and cover the ending portions 420-9 and 420-8 of the fastening member 420 simultaneously with covering the recessed portions 410-7 and 410-8 of the housing 410. Accordingly, the fastening member 420 may be stably fixed to the housing 410 without using the bracket 430. The fasteners 433-1 and 433-2 may restrict or limit movement of the button member 420-1 in a rear direction along the thickness direction, since edges of the fasteners overlap the stepped portion at the end portion of the button member 420-1.

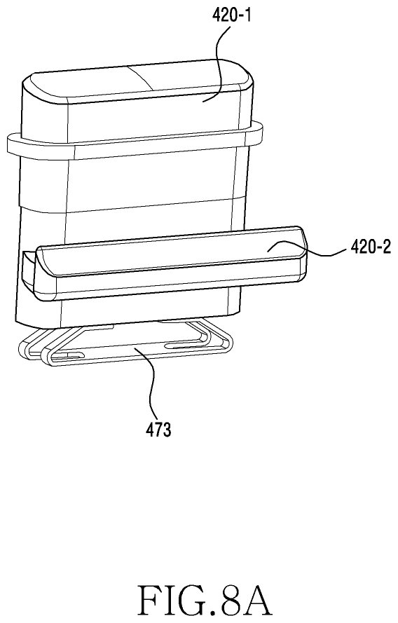

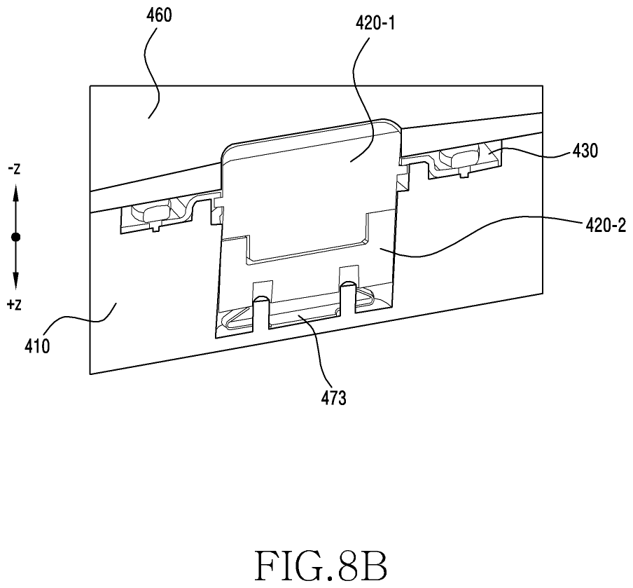

FIG. 8A is a diagram for explaining a plate spring arranged between a fastening member and a cavity portion according to an embodiment. FIG. 8B is a diagram for explaining the plate spring arranged between the fastening member and the cavity portion according to an embodiment.

Referring to FIGS. 8A and 8B, a plate spring 473 may be disposed below and extend from the hook member 420-2 in the cavity portion of the housing 410. Accordingly, when a user presses the button member 420-1, the spring 473 may be pressed against the housing 410, and a repulsive force due to the elasticity force of the plate spring 473 may be applied to the user.

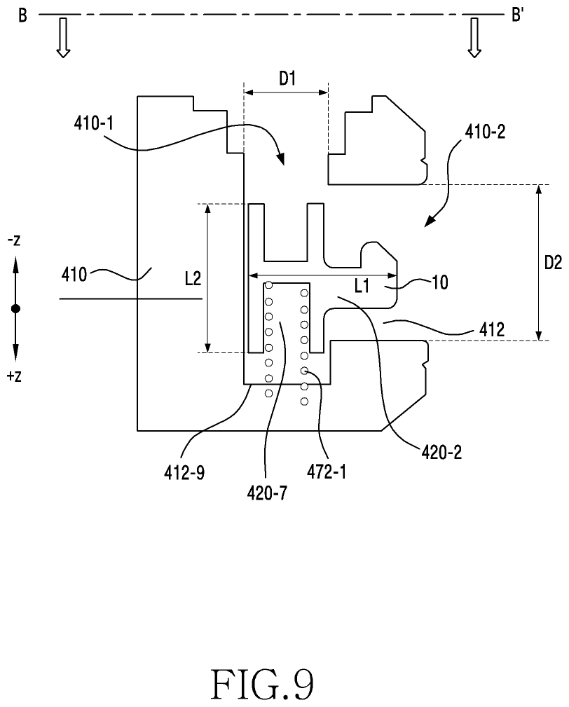

FIG. 9 is a sectional view illustrating a section B-B′ of FIG. 6 according to an embodiment.

Referring to FIG. 9, the hook member 420-2 may be arranged within the cavity portion 412 of the housing 410. The hook member 420-2 may be seated in a seating portion 412-9 within the cavity portion 412 of the housing 410. The hook member 420-2 may include a groove 420-7 formed toward (e.g., open toward) a front direction (e.g., +z direction) of the electronic device 400, and the second spring 472-1 may be arranged within the groove 420-7. The second spring 472-1 may be arranged between the seating portion 412-9 and the hook member 420-2 within the cavity portion 412, and apply an elastic force from the housing 410 toward the hook member 420-2, that is, in a direction away from a surface of the housing 410 which provides a bottom of the seating portion 412-9.

According to an embodiment, a width (L1) as a total width (or maximum width) of the hook member 420-2 in a width direction (e.g., direction perpendicular to −z direction, such as along the x direction) may be greater than a width (D1) as a total width of a first opening 410-1 formed toward a rear direction (e.g., −z direction) of the electronic device 400. According to an embodiment, a length (L2) as a total length of the hook member 420-2 in a length direction (e.g., along the thickness direction, such as the z direction) may be smaller than a length (D2) as a total length of a second opening 410-2 formed toward a side direction (e.g., direction perpendicular to z direction) of the electronic device 400.

In an embodiment, the seating portion 412-9 and the first opening 410-1 may overlap each other along the z direction to provide a movement space for the button member 420-1 and/or the hook member 420-2 of the fastening member 420, and the fastening member 420 may be reciprocally moveable along such path. The second opening 410-2 may provide a movement space for the attachment portion 10 of the fastening member 410 which moves together with the button member 420-1 and/or the hook member 420-2.

According to an embodiment, the hook member 420-2 may include an attachment portion 10, and an ending portion of the attachment portion 10 may protrude toward the front direction (e.g., +z direction) or the rear direction (e.g., −z direction) of the electronic device.

Here, a distal end of the attachment member 10 (e.g., the ending portion) may be disposed inwardly from an outermost surface of the housing 410 through which the second opening 410-2 is defined. The attachment portion 10 may include a protruded portion extended from a common thickness (e.g., where line L1 is defined), in the −z direction, to provide a step or a hook at the distal end of the attachment portion.

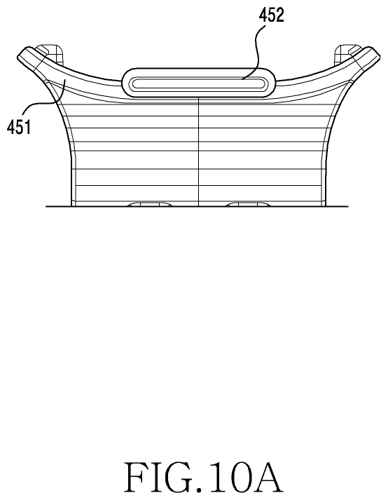

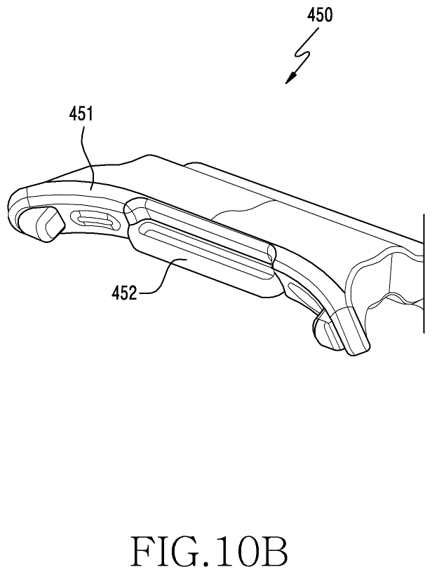

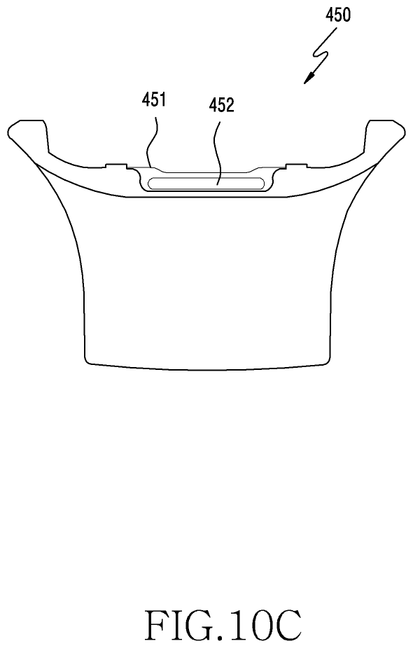

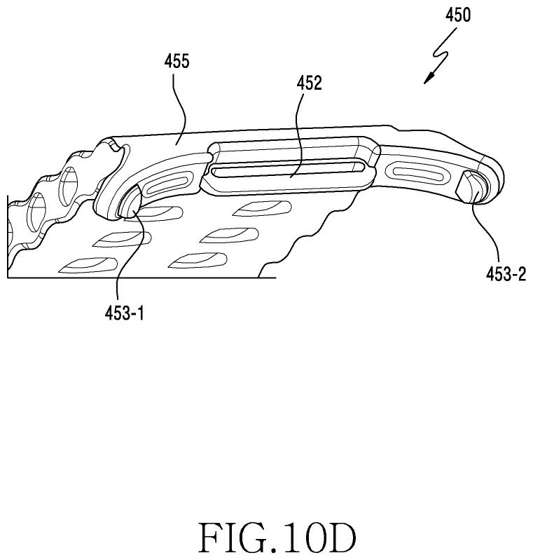

FIGS. 10A and 10B is a diagram illustrating an attachment portion protruding from a strap adapter of a strap according to an embodiment.

Referring to FIGS. 10A and 10B, the strap adapter 451 included in the strap 450 of an embodiment may include the attachment portion 452. For example, the attachment portion 452 may be formed to protrude from one side of the strap adapter 451 at a central portion of the strap adapter 451. Referring back to FIG. 4, for example, the attachment portion 452 may protrude further from the strap adapter 451 along the −x direction. The attachment portion 452 of the strap adapter 451 may be formed as a hooking structure and be attachable to the hook member 420-2 arranged in a cavity portion (e.g., 412 of a housing (e.g., 410).

FIG. 10C is a diagram illustrating an attachment portion not protruding from a strap adapter of a strap according to an embodiment.

Referring to FIG. 10C, the strap adapter 451 included in the strap 450 of an embodiment may include the attachment portion 452. For example, the attachment portion 452 may be formed not to protrude from one side of the strap adapter 451 at a central portion of the strap adapter 451. Referring back to FIG. 4, for example, the attachment portion 452 may not protrude further from the strap adapter 451 along the-x direction (like in a planar direction of the xy plane). The attachment portion 452 of the strap adapter 451 may be formed as a hooking structure and be attachable to the hook member 420-2 arranged in a cavity portion (e.g., 412) of a housing (e.g., 410).

A protrusion distance of the hook member 420-2 along the +x direction may vary depending on the protrusion distance of the attachment portion 452 along the-x direction and toward the cavity of the electronic device 400. According to an embodiment, a degree to which the hook member 420-2 protrudes toward the side direction of the electronic device 400 (e.g., relative to the outermost surface of the housing 410) when the attachment portion 452 does not protrude from the strap adapter 451 may be greater than a degree to which the hook member 420-2 protrudes toward the side direction of the electronic device 400 when the attachment portion 452 protrudes from the strap adapter 451. Accordingly, when the attachment portion 452 does not protrude from the strap adapter 451 (or when the attachment portion 452 protrudes only slightly), the strap 450 may be effectively attached to the housing 410 while enhancing the design perfection of an appearance of the strap 450 of the electronic device 400 without deteriorating the quality of the appearance of the strap 450.

FIG. 10D is a diagram for explaining an example of an attachment portion and a protrusion guide formed in a strap according to an embodiment.

Referring to FIG. 10D, the strap 450 of an embodiment may include the attachment portion 452 and protrusion guides 453-1 and 453-2. For example, one end of the strap body 455 which is closest to the electronic device 400 along the direction may be formed in a shape or cross-sectional provide corresponding to that of a cavity portion (e.g., 412) of the housing 410, and the attachment portion 452 may be arranged at a central portion of the one end of the strap body 455 (e.g., center taken along the y direction). For example, the protrusion guides 453-1 and 453-2 may be formed in a shape corresponding to recesses (e.g., 412-1 and 412-2) formed in the cavity portion (e.g., 412) of the housing (e.g., 410), and may be arranged at opposing ends of the one end of the strap body 455, respectively. For example, the attachment portion 452 and the protrusion guides 453-1 and 453-2 may perform a function of a strap adapter (e.g., 451).

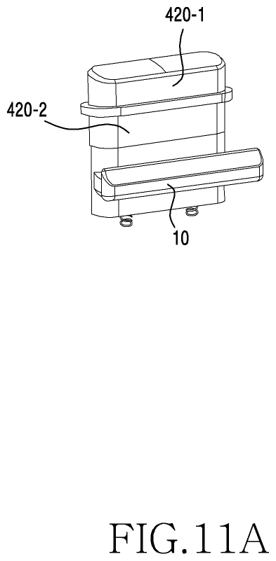

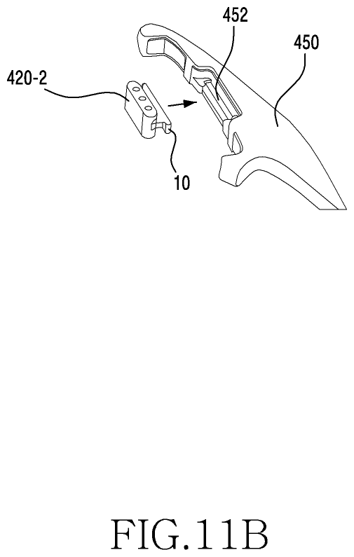

FIGS. 11A and 11B are diagrams illustrating an example in which a hook member is attached to an attachment portion of a strap according to an embodiment.

Referring to FIGS. 11A and 11B, for example, the attachment portion 10 of the hook member 420-2 coupled to the button member 420-1 and moveable therewith, may include a hooking structure formed to face one direction when the strap 450 is attached to the housing 410. The attachment portion 452 formed on the strap 450 may include a hooking structure formed to face a direction opposite to the one direction in which the hooking structure of the fastening member 420 extends. Accordingly, the hooking structure of the attachment portion 10 of the hook member 420-2 coupled to the button member 420-1 may be attached to the strap 450 at the hooking structure of the attachment portion 452 formed on the strap 450.

Referring to FIG. 11B, the fastening member 420 (represented by the attachment portion 10) may face the strap 450 along the x direction as a coupling direction (e.g., arrow in FIG. 11B) of the electronic device 400. In detachable coupling of the electronic device 400 to the strap 450, the attachment portion 10 may face the attachment portion 452 and be engaged with each other to restrict disengagement of the housing 410 and the strap 450 from each other. The housing 410 and the strap 450 may be detachably coupled to each other by detachable coupling of the attachment portion 10 to the attachment portion 452, without being limited thereto.

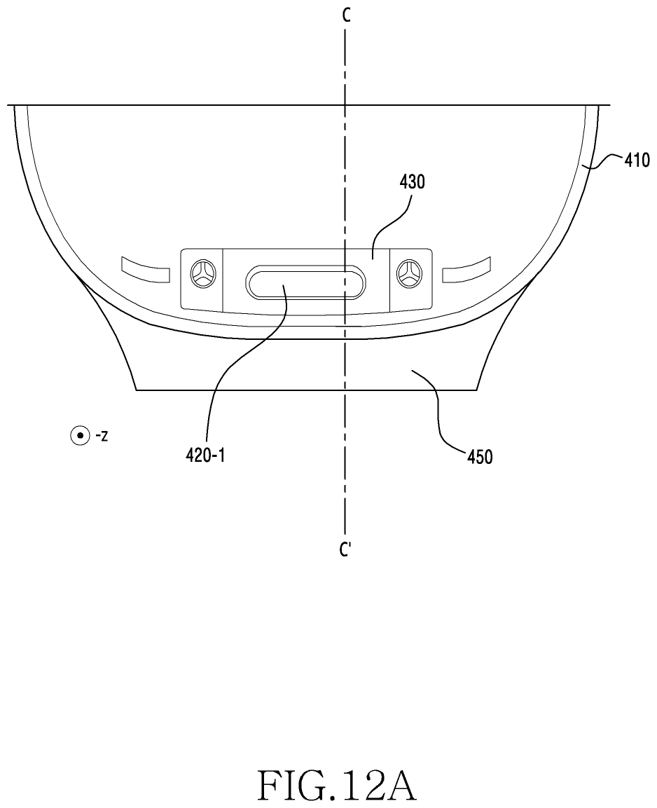

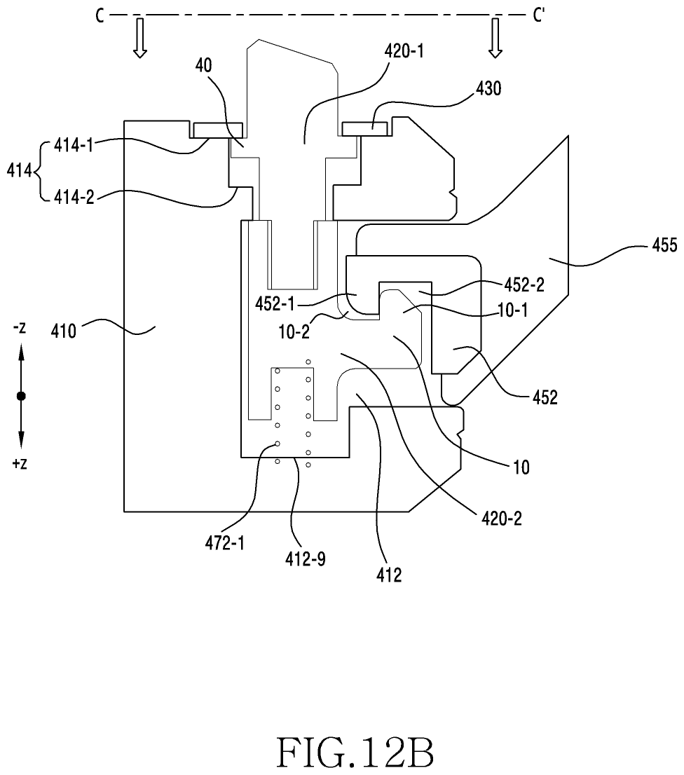

FIG. 12A is a diagram illustrating the arrangement of a button member when looking at an electronic device from a rear direction of the electronic device according to an embodiment. FIG. 12B is a sectional view illustrating a section C-C′ of FIG. 12A according to an embodiment.

Referring to FIGS. 12A and 12B, the strap 450 of an embodiment may be attached to the housing 410. According to an embodiment, the button member 420-1 may be coupled to the hook member 420-2 and be arranged in the cavity portion 412 of the housing 410, to be exposed to outside the housing 410 by the cavity portion 412. The hook member 420-2 may be arranged in the seating portion 412-9 within the cavity portion 412. In addition, the second spring 472-1 may be arranged between the hook member 420-2 and the seating portion 412-9 within the cavity portion 412.

According to an embodiment, the opening 414 of the housing 410 may be formed to have a step-like shape in cross-section. For example, the opening 414 may include a first support portion 414-1 as a first support surface and a second support portion 414-2 as a second support surface. Accordingly, when the button member 420-1 is inserted into the opening 414 and moves toward the cavity portion 412 in the +z direction, a protrusion portion 40 surrounding the button member 420-1 may be supported by the second supporting portion 414-2. The second support surface may restrict further movement of the button member 420-1 in a direction toward the seating portion 412-9.

According to an embodiment, the bracket 430 may be fixed onto the first supporting portion 414-1 of the opening 414 while surrounding the button member 420-1. Accordingly, when the button member 420-1 moves toward the outside of the electronic device 400 through the opening 414 in the-z direction, the bracket 430 fixed to the opening 414 may block the movement of the protrusion portion 40 surrounding the button member 420-1 and prevent the button member 420-1 from being separated from the housing 410 and further extending to the outside of the electronic device 400 through the opening 414.

According to an embodiment, the attachment portion 10 of the hook member 420-2 may include a hooking structure formed protruded toward the rear direction (e.g., −z direction) of the electronic device 400. The hooking structure of the attachment portion 10 of the hook member 420-2 may be formed by a protrusion portion 10-1 of the attachment portion 10. In addition, the hook member 420-2 may include a recessed portion 10-2 formed by the protrusion of the protrusion portion 10-1.

In addition, the attachment portion 452 of the strap 450 may include a hooking structure facing toward the front direction (e.g., +z direction) of the electronic device 400 when the strap 450 is attached to the housing 410. The hooking structure of the attachment portion 452 of the strap 450 may be formed by a protrusion portion 452-1 of the attachment portion 452 of the strap 450. In addition, the attachment portion 452 of the strap 450 may include a recessed portion 452-2 formed by the protrusion of the protrusion portion 452-1.

According to an embodiment, the strap 450 may be attached to the housing 410, by engagement of the hooking structure of the attachment portion 452 of the strap 450 to the hooking structure of the attachment portion 10 of the hook member 420-2 of the housing 410. The attachment portion 452 of the strap 450 may be formed to accommodate at least a portion of the attachment portion 10 of the hook member 420-2 of the housing 410 when the strap 450 is attached to the housing 410. For example, the protrusion portion 10-1 of the hook member 420-2 may be accommodated in the recessed portion 452-2 of the attachment portion 452 of the strap 450. Also, for example, the protrusion portion 452-1 of the attachment portion 452 of the strap 450 may be accommodated in the recessed portion 10-2 of the hook member 420-2. The strap 450 which is detachably attached to the housing 410 includes the protrusion portions 10-1 and 452-1 overlapping each other along the coupling direction (e.g., the x direction).

Referring to FIG. 12B, since the spring 472-1 biases the fastening member 420 in the rear direction (e.g., the −z direction), the strap 450 may be detachably attached to the housing 410 solely under the force of one or more springs between the fastening member 420 and the housing 410.

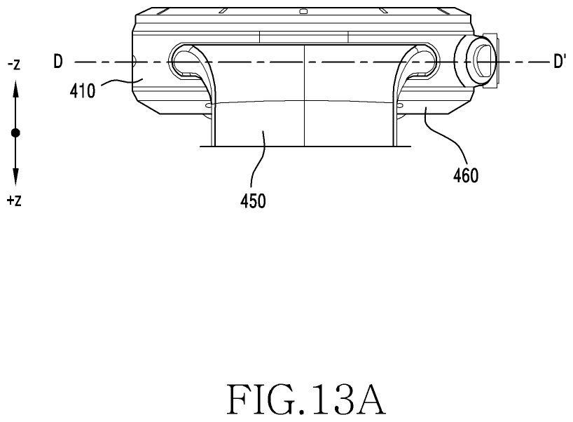

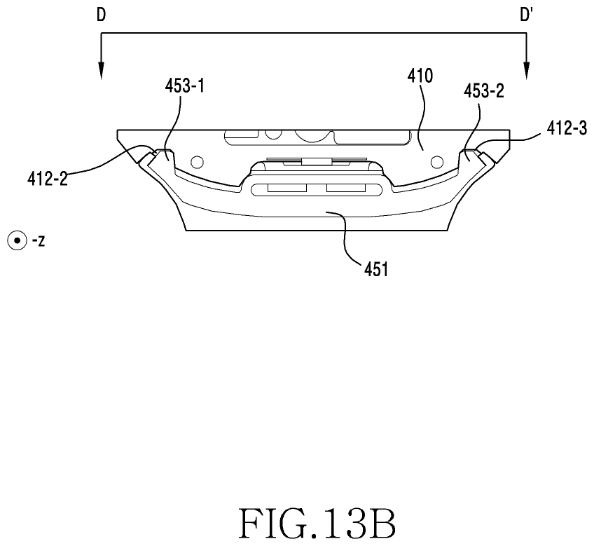

FIG. 13A is a diagram illustrating a strap attached to a housing when looking at a side direction of an electronic device according to an embodiment. FIG. 13B is a sectional view illustrating a section D-D′ of FIG. 13A according to an embodiment.

Referring to FIGS. 13A and 13B, the strap 450 of an embodiment may be attached to the housing 410. For example, the first protrusion guide 453-1 included in the strap adapter 451 may be inserted into the second recess 412-2 of the cavity portion 412 of the housing 410, and the second protrusion guide 453-2 included in the strap adapter 451 may be inserted into the second recess 412-2 of the cavity portion 412 of the housing 410. Accordingly, the first recess 412-1 and the second recess 412-2 may prevent the first protrusion guide 453-1 and the second protrusion guide 453-2 of the strap adapter 451 from moving in a side direction of the electronic device 400, such as along the y direction. For example, the first recess 412-1 and the second recess 412-2 may prevent the strap adapter 451 from moving in a direction perpendicular to a direction in which the strap adapter 451 moves into the cavity portion 412 of the housing 410 and is attached to the housing 410.

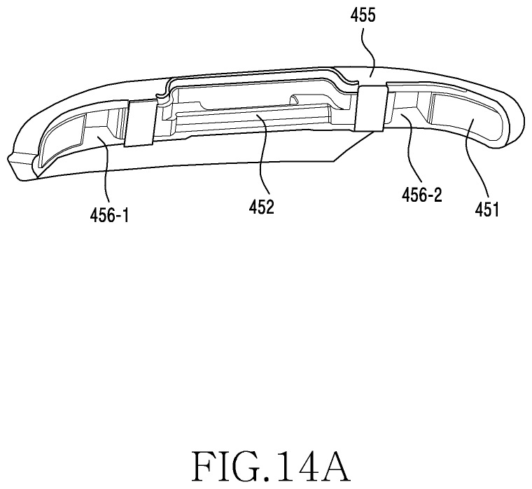

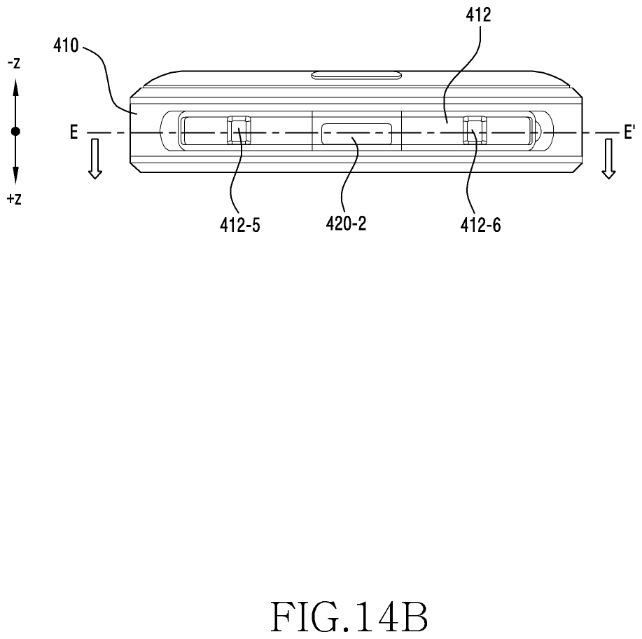

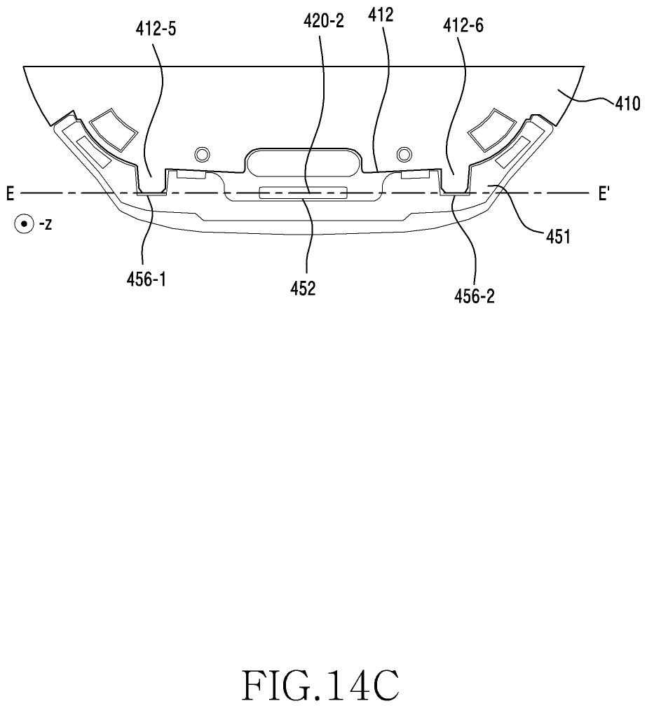

FIG. 14A is a diagram for explaining a recess formed in a strap according to an embodiment. FIG. 14B is a diagram for explaining a cavity portion in which a protrusion guide is formed according to an embodiment. FIG. 14C is a sectional view illustrating a section E-E′ of FIG. 14B according to an embodiment.

Referring to FIGS. 14A to 14C, protrusion guides 412-5 and 412-6 formed in the cavity portion 412 of the housing 410 may be inserted into recesses 456-1 and 456-2 of the strap adapter 451.

Referring to FIG. 14A, the strap adapter 451 of an embodiment may include the third recess 456-1 and the fourth recess 456-2. In addition, the attachment portion 452 may be formed in a central portion of the strap adapter 451. For example, the attachment portion 452 of the strap adapter 451 may be formed between the third recess 456-1 and the fourth recess 456-2.

Referring to FIG. 14B, the cavity portion 412 of the housing 410 of an embodiment may include the third protrusion guide 412-5 and the fourth protrusion guide 412-6. In addition, the hook member 420-2 may be arranged in a central portion of the cavity portion 412 of the housing 410. For example, the hook member 420-2 may be arranged between the third protrusion guide 412-5 and the fourth protrusion guide 412-6 in the cavity portion 412 of the housing 410.

Referring to FIG. 14C, the attachment portion 452 of the strap adapter 451 of an embodiment may be attached to the hook member 420-2 arranged in the cavity portion 412 of the housing 410. For example, the third protrusion guide 412-5 and the fourth protrusion guide 412-6 formed in the cavity portion 412 of the housing 410 may be inserted into the third recess 456-1 and the fourth recess 456-2 formed in the strap adapter 451.

Accordingly, the third recess 456-1 and the fourth recess 456-2 may prevent the third protrusion guide 412-5 and the fourth protrusion guide 412-6 from moving in a side direction of the electronic device 400. For example, the third recess 456-1 and the fourth recess 456-2 may prevent the strap adapter 451 from moving in a direction perpendicular to a direction in which the strap adapter 451 moves to the cavity portion 412 of the housing 410 and is attached to the housing 410.

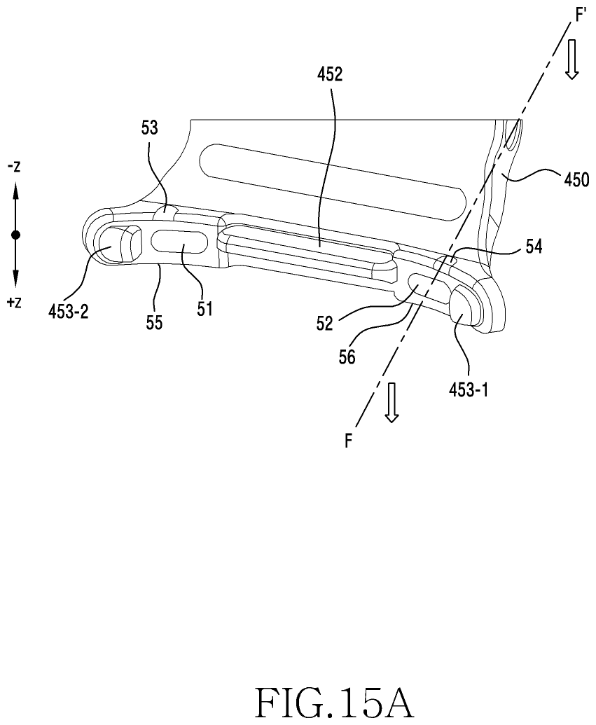

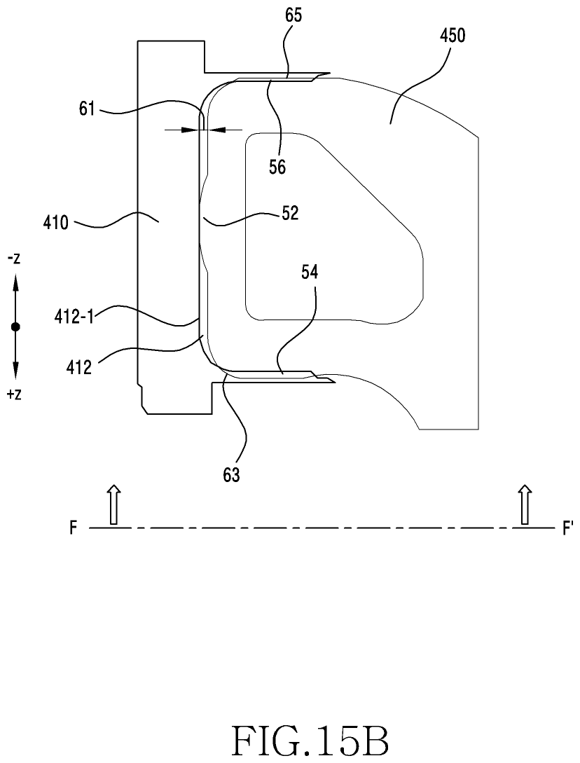

FIG. 15A is a diagram illustrating a protrusion formed on a strap according to an embodiment. FIG. 15B is a sectional view illustrating a portion of a section F-F′ of FIG. 15A, in a state where a strap is attached to a housing according to an embodiment.

Referring to FIGS. 15A and 15B, when the strap 450 is attached to the housing 410, protrusions (e.g., 51, 52, 53, 54, 55, and 56) formed on the strap 450 of an embodiment may compensate for a tolerance between the strap 450 and the housing 410 and prevent the strap 450 from flowing or undesirably moving within the housing 410.

Referring to FIG. 15A, the protrusions 51 and 52 may be formed on a face, which faces the housing 410, of one end of the strap 450 of an embodiment. For example, on the face, which faces the housing 410, of the one end of the strap 450, the first protrusion 51 may be formed between the second protrusion guide 453-2 and the attachment portion 452, and the second protrusion 52 may be formed between the first protrusion guide 453-1 and the attachment portion 452.

The protrusions 53, 54, 55, and 56 may be formed at an edge portion of the one end of the strap 450 of an embodiment. For example, at a bent edge portion of the face, which faces the housing 410, of the one end of the strap 450, the third protrusion 53 and the fourth protrusion 54 may be formed with an attachment portion 452 located therebetween. For example, at a bent edge portion of the face, which faces the housing 410, of the one end of the strap 450, the fifth protrusion 55 and the sixth protrusion 56 may be formed with the attachment portion 452 located therebetween.

According to an embodiment, the first protrusion 51, the third protrusion 53, and the fifth protrusion 55 may be arranged to at least partially overlap each other. According to an embodiment, the second protrusion 52, the fourth protrusion 54, and the sixth protrusion 56 may be arranged to at least partially overlap each other.

Referring to FIG. 15B, when the strap 450 of an embodiment is attached to the housing 410, the second protrusion 52 may come in close contact with the lateral wall 412-1 of the cavity portion 412 of the housing 410. According to an embodiment, the second protrusion 52 may be formed of a material having elastic force. According to an embodiment, when the strap 450 is attached to the housing 410, the second protrusion 52 may apply elastic force toward the lateral wall 412-1 of the cavity portion 412 and compensate for a tolerance 61 or gap between the lateral wall 412-1 of the cavity portion 412 and the strap 450. In addition, the strap 450 may be prevented from flowing within the housing 410.

According to an embodiment, the fourth protrusion 54 may be formed to partially overlap with a wall 63 extending from a portion, which is closer to a rear face of the electronic device 400, of the lateral wall 412-1 of the cavity portion 412 of the housing 410, when the strap 450 is attached to the housing 410. In addition, according to an embodiment, the sixth protrusion 56 may be formed to partially overlap with a wall 65 extending from a portion, which is closer to a front face of the electronic device 400, of the lateral wall 412-1 of the cavity portion 412 of the housing 410, when the strap 450 is attached to the housing 410. Here, the walls 412-1, 63 and 65 may contribute to defining the cavity of the housing 410. According to an embodiment, the fourth protrusion 54 and the sixth protrusion 56 may be formed of a material having elastic force. Accordingly, the fourth protrusion 54 and the sixth protrusion 56 may compensate for tolerances or gaps between the edge portions of the one end of the strap 450 and the walls 63 and 65 of the cavity portion 412 of the housing 410, when the strap 450 is attached to the housing 410. In addition, the strap 450 may be prevented from flowing within the housing 410. Here, the tolerances or gaps may be defined between facing surfaces of the housing 410 and the strap 450, such as including inner surfaces of the housing 410 which define the cavity and the outer surfaces of the strap 450 which face the inner surface of the housing 410.

According to an embodiment, a degree to which the fourth protrusion 54 partially overlaps with the wall 63 of the cavity portion 412 may be greater than a degree to which the sixth protrusion 56 overlaps with the wall 65 of the cavity portion 412. Accordingly, when the strap 450 is attached to the housing 410, the hook member 420-2 may be attached more stably to the attachment portion 452.

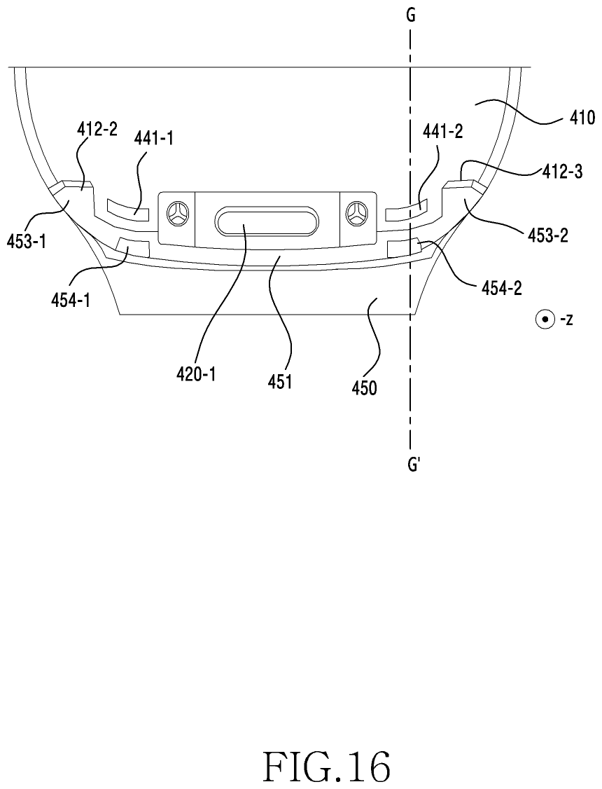

FIG. 16 is a diagram for explaining a body magnet arranged in a housing and a strap magnet arranged in a strap according to an embodiment.

Referring to FIG. 16, according to an embodiment, the body magnets 441-1 and 441-2 may be arranged in the housing 410, and the strap magnets 454-1 and 454-2 may be arranged in the strap 450, where an attractive force due to a magnetic force is applied between the body magnets 441-1 and 441-2 of the housing 410 and the strap magnets 454-1 and 454-2 of the strap 450 while the strap 450 is being attached to the housing 410. For example, at least one of the body magnets 441-1 and 441-2 and the strap magnets 454-1 and 454-2 of the strap 450 may include a magnetic material having a magnetic force of about 1800 Gauss or more.

According to an embodiment, the first body magnet 441-1 and the second body magnet 441-2 may be arranged in a portion, which is adjacent to the cavity portion 412, of the housing 410. In addition, the first body magnet 441-1 may be arranged between the first recess 412-2 and the button member 420-1, and the second body magnet 441-2 may be arranged between the second recess 412-3 and the button member 420-1.

According to an embodiment, when the strap 450 is attached to the housing 410, the strap magnets 454-1 and 454-2 may be arranged at positions corresponding to the body magnets 441-1 and 441-2, at the one end of the strap 450. For example, in the strap adapter 451, the first strap magnet 454-1 may be arranged between the first protrusion guide 453-1 and the attachment portion 452, and the second strap magnet 454-2 may be arranged between the second protrusion guide 453-2 and the attachment portion 452.

According to an embodiment, the body magnets 441-1 and 441-2 and the strap magnets 454-1 and 454-2 may assist in alignment between the strap 450 and the housing 410 while the strap 450 is being fastened to the housing 410, and may present a user with a guide for fastening the strap 450. For example, the body magnets 441-1 and 441-2 and the strap magnets 454-1 and 454-2 may provide, for example, a clicking sound when the strap 450 is fastened to the housing 410, and may enhance a user's experience of use.

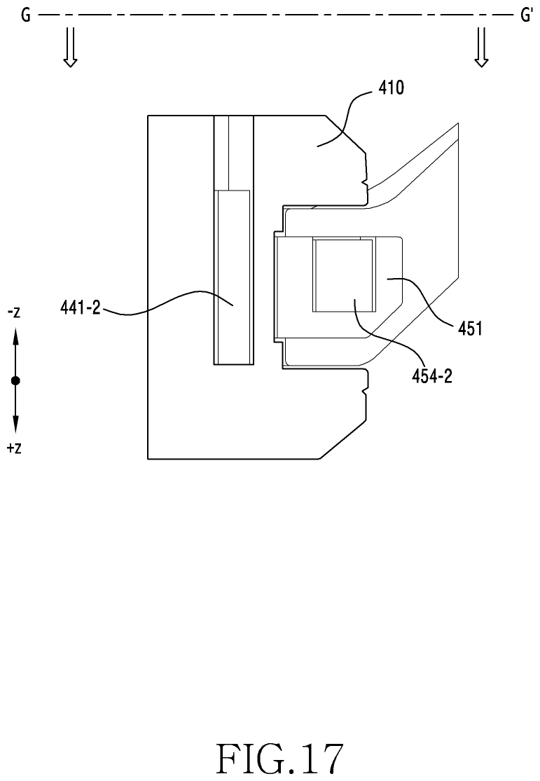

FIG. 17 is a sectional view illustrating a section G-G′ of FIG. 16 according to an embodiment.

Referring to FIG. 17, the second body magnet 441-2 may be arranged within the housing 410, and the second strap magnet 454-2 may be arranged within the strap adapter 451. In addition, when looking at the side direction of the electronic device 400, the second body magnet 441-2 may at least partially overlap the second strap magnet 454-2.

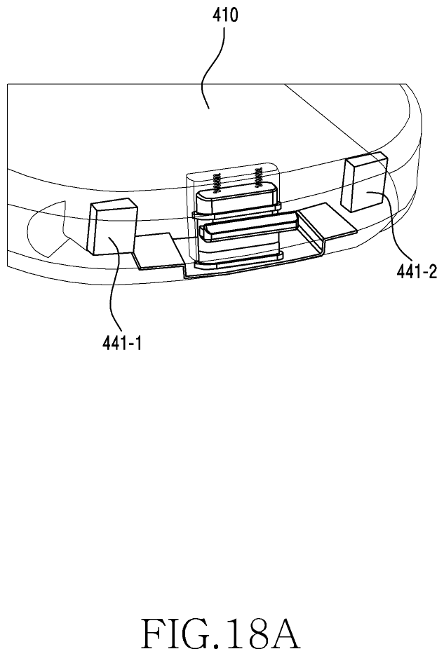

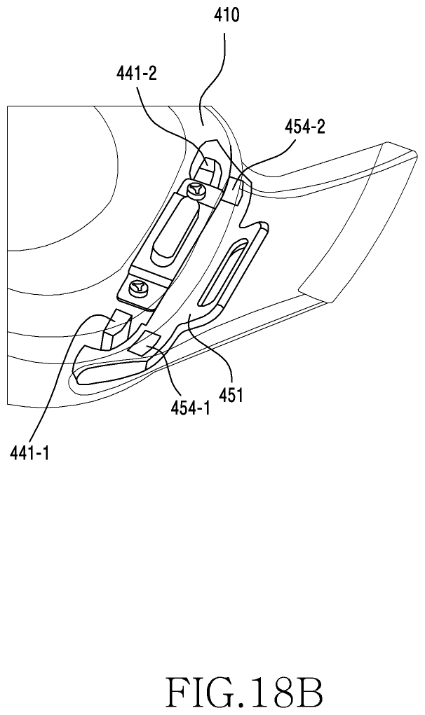

FIGS. 18A and 18B are drawings illustrating examples of a body magnet and a strap magnet arranged in an electronic device according to an embodiment.

Referring to FIGS. 18A and 18B, the first body magnet 441-1 and the second body magnet 441-2 of an embodiment may be inserted and arranged in the housing 410, and the first strap magnet 454-1 and the second strap magnet 454-2 may be inserted and arranged in the strap adapter 451.

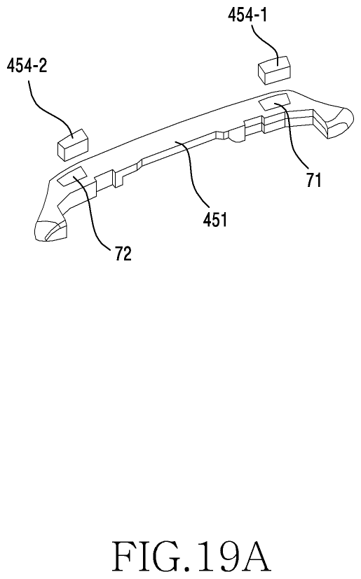

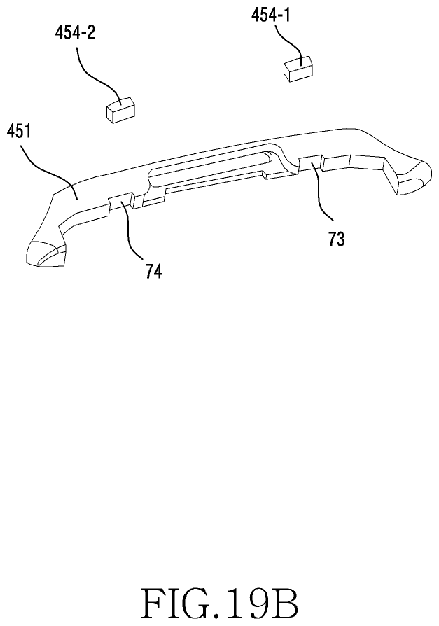

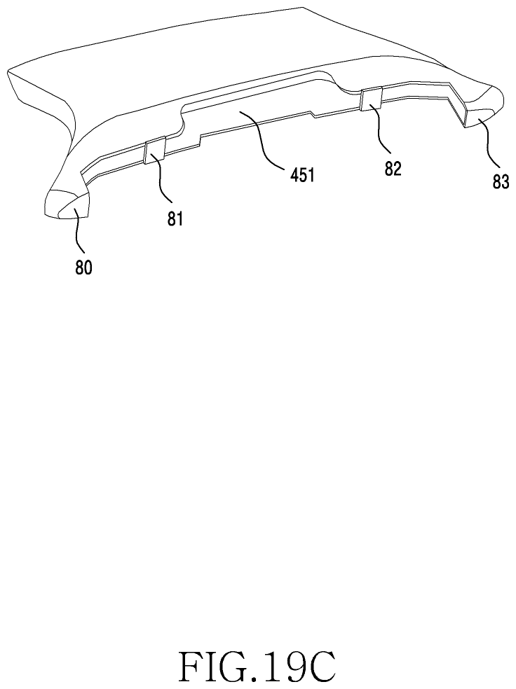

FIGS. 19A to 19C are drawings illustrating examples in which a strap magnet is arranged in a strap adapter according to an embodiment.

Referring to FIG. 19A, the first strap magnet 454-1 and the second strap magnet 454-2 of an embodiment may be inserted into recesses 71 and 72 formed in the strap adapter 451, respectively. For example, the first strap magnet 454-1 and the second strap magnet 454-2 may be attached, by bonding, to the recesses 71 and 72 formed in the strap adapter 451, respectively.

According to an embodiment, after the strap 450 including the strap adapter 451 and the strap body 455 is formed by insert injection molding, the first strap magnet 454-1 and the second strap magnet 454-2 may be inserted into the recesses 71, 72, respectively. Accordingly, the magnetism of the first strap magnet 454-1 and the second strap magnet 454-2 may be prevented from being removed by heat in a process of forming the strap 450.

Referring to FIG. 19B, the first strap magnet 454-1 and the second strap magnet 454-2 of an embodiment may be fitted into grooves 73 and 74 formed in a face, which faces the housing 410, of the strap adapter 451. For example, the first strap magnet 454-1 and the second strap magnet 454-2 may be attached to the grooves 73 and 74 by bonding, respectively.

According to an embodiment, after the strap 450 including the strap adapter 451 and the strap body 455 is formed by insert injection molding, the first strap magnet 454-1 and the second strap magnet 454-2 may be fitted into the grooves 73 and 74 by bonding, respectively.

Accordingly, the magnetism of the first strap magnet 454-1 and the second strap magnet 454-2 may be prevented from being removed by heat in a process of forming the strap 450.

Referring to FIG. 19C, a plurality of strap magnets 80, 81, 82, and 83 of an embodiment may be spaced apart from each other and attached to a face, which faces the housing 410, of the strap adapter 451. For example, when the strap 450 is attached to the housing 410, body magnets (not shown) may be arranged at positions corresponding to the plurality of strap magnets 80, 81, 82, and 83 in the housing 410. For example, the plurality of strap magnets 80, 81, 82, and 83 may be each attached to the face, which faces the housing 410, of the strap adapter 451 by bonding.

According to an embodiment, after the strap 450 including the strap adapter 451 and the strap body 455 is formed by insert injection molding, the plurality of strap magnets 80, 81, 82, and 83 may be each disposed on a face, which faces the housing 410, of the strap adapter 451. Accordingly, the magnetism of the plurality of strap magnets 80, 81, 82, and 83 may be prevented from being removed by heat in a process of forming the strap 450.

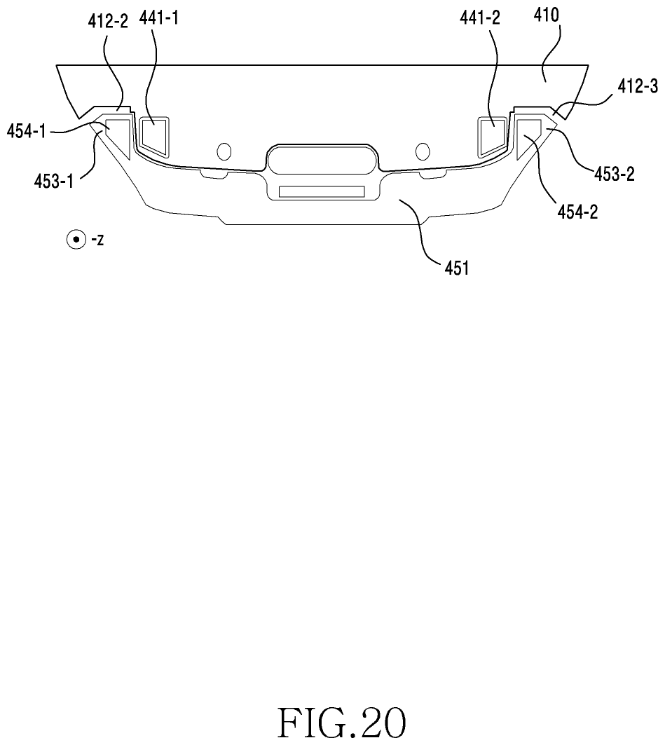

FIG. 20 is a diagram for explaining the arrangement of a body magnet and a strap magnet according to an embodiment.

Referring to FIG. 20, the strap magnets 454-1 and 454-2 of an embodiment may be arranged in the protrusion guides 453-1 and 453-2 of the strap adapter 451, and the body magnets 441-1 and 441-2 may be arranged at positions adjacent to the recesses 412-2 and 412-3 in the housing 410.

For example, the first strap magnet 454-1 may be arranged within the first protrusion guide 453-1 of the strap adapter 451, and the second strap magnet 454-2 may be arranged within the second protrusion guide 453-2 of the strap adapter 451.

In addition, for example, the first body magnet 441-1 may be arranged at a position adjacent to the first recess 412-1 in the housing 410, and the second body magnet 441-2 may be arranged at a position adjacent to the second recess 412-2 in the housing 410.

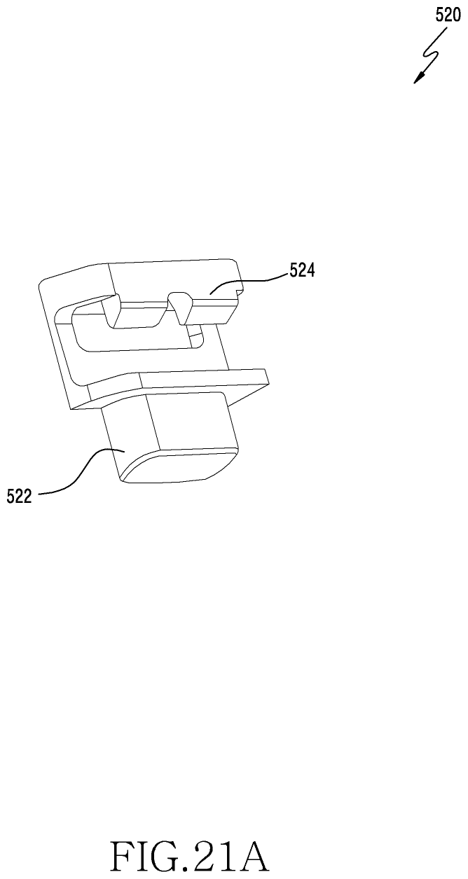

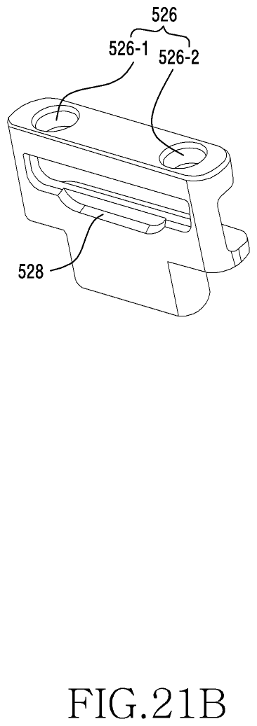

FIGS. 21A and 21B are diagrams illustrating an integrally formed fastening member according to an embodiment. FIGS. 21A and 21B may be perspective views of a +x direction and a −x direction side of the fastening member 520, respectively.

Referring to FIGS. 21A and 21B, an integrally formed fastening member 520 of an embodiment may include a button portion 522, a hook portion 524, at least one groove portion 526 and a groove 528, forming a single, continuous body of the fastening member 520. For example, the button member 420-1 and the hook member 420-2 may be formed integrally and form the fastening member 520, the button portion 522 of the integrally formed fastening member 520 may correspond to the button member 420-1, and the hook portion 524 may correspond to the hook member 420-2. According to an embodiment, the button portion 522 may be formed to extend from the hook portion 524 toward the rear direction of the electronic device 400, when the integrally formed fastening member 520 is arranged in the cavity portion 412 of the housing 410.

At least one spring (not shown) may be arranged in the at least one groove portion 526 as a spring groove of an embodiment. The groove 528 of an embodiment may be supported by a locking member 530 to be described later, when the fastening member 520 is arranged within the cavity portion 412.

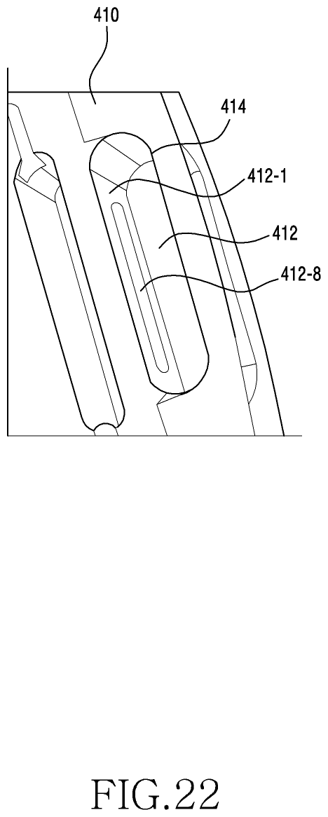

FIG. 22 is a diagram illustrating an example of a recess formed in a lateral wall of a cavity portion according to an embodiment.

Referring to FIG. 22, a seating portion 412-8 where a locking member 530 to be described later for supporting the fastening member 520 arranged within the cavity portion 412 is to be arranged may be formed in the lateral wall 412-1 of the cavity portion 412 of the housing 410 of an embodiment. For example, the seating portion 412-8 may be formed in a lower portion of the opening 414 of the lateral wall 412-1 of the cavity portion 412. For example, the seating portion 412-8 may be formed in a central portion of the lateral wall 412-1 of the cavity portion 412. For example, the seating portion 412-8 may be formed as a groove having a depth corresponding to a thickness of the locking member 530 to be described later.

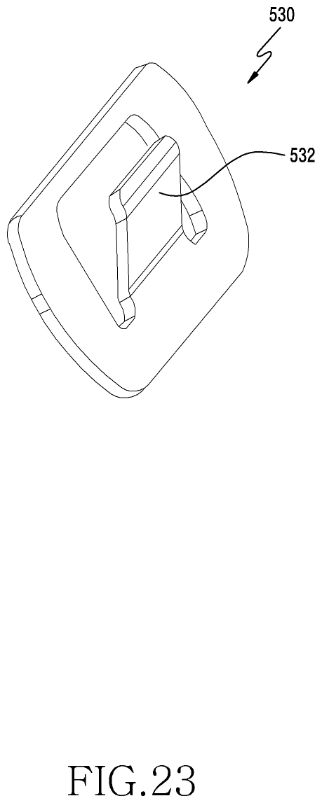

FIG. 23 is a diagram illustrating an example of a locking member according to an embodiment.

Referring to FIG. 23, the locking member 530 arranged in the seating portion 412-8 formed in the lateral wall 412-1 of the cavity portion 412 of an embodiment may include a hanging portion 532. The hanging portion 532 may prevent the fastening member 520 inserted into the cavity portion 412 through the opening 414 from being separated to the outside of the housing 410 through the opening 414. The locking member 530 of an embodiment may be fixed to the seating portion 412-8. For example, the locking member 530 may be fixed to the seating portion 412-8 by welding or may be fixed to the seating portion 412-8 through an adhesive material, but is not limited thereto. For example, the seating portion 412-8 formed in the cavity portion 412 of the housing 410 may include a metal material.

According to an embodiment, the locking member 530 may be formed of an elastic material. For example, the locking member 530 may be formed of a material such as metal (e.g., stainless steel). In a process of assembling the fastening member 520 to the housing 410 by using elastic force, the hanging portion 532 may be bent toward the inside of the electronic device 400 while presenting a space where the fastening member 520 is to be inserted into the housing 410. After the fastening member 520 is inserted into the housing 410, a protruded shape of the hanging portion 532 may be again restored to the original and be caught by one face of the fastening member 520 and prevent the fastening member 520 from being separated from the housing 410.

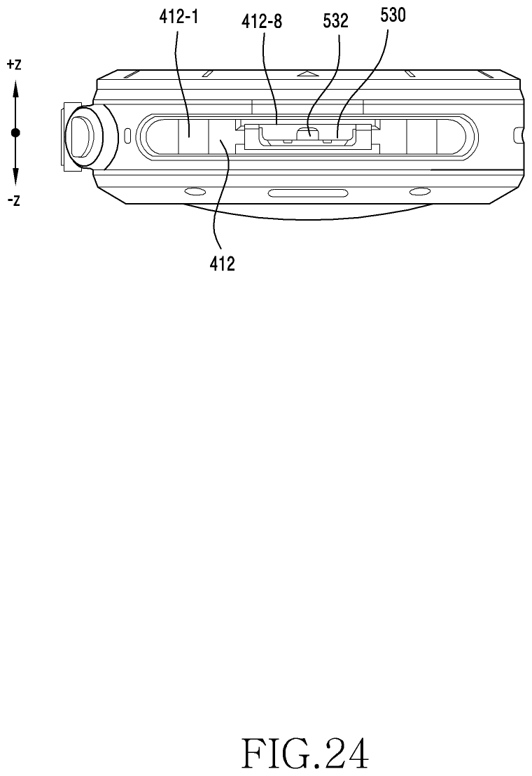

FIG. 24 is a diagram illustrating an example of a locking member disposed on a seating portion formed in a lateral wall of a cavity portion according to an embodiment.

According to an embodiment, the locking member 530 may be arranged in the seating portion 412-8 of the lateral wall 412-1 of the cavity portion 412. According to an embodiment, the locking member 530 may be arranged in a central portion of the lateral wall 412-1 of the cavity portion 412. According to an embodiment, the hanging portion 532 of the locking member 530 may be attached to the lateral wall 412-1 of the cavity portion 412 and face the front direction (e.g., +z direction) of the electronic device 400.

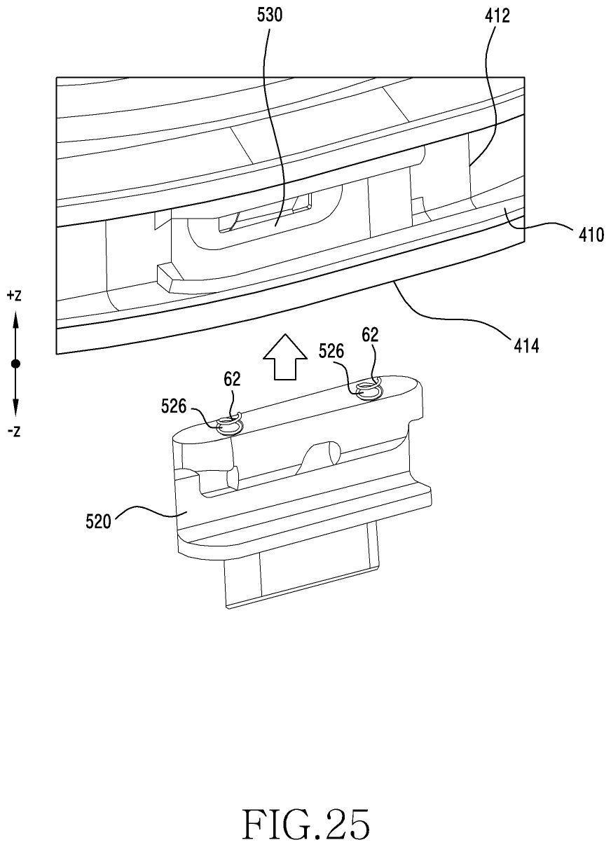

FIG. 25 is a diagram illustrating an example in which an integral fastening member is inserted into a cavity portion where a locking member is arranged according to an embodiment.

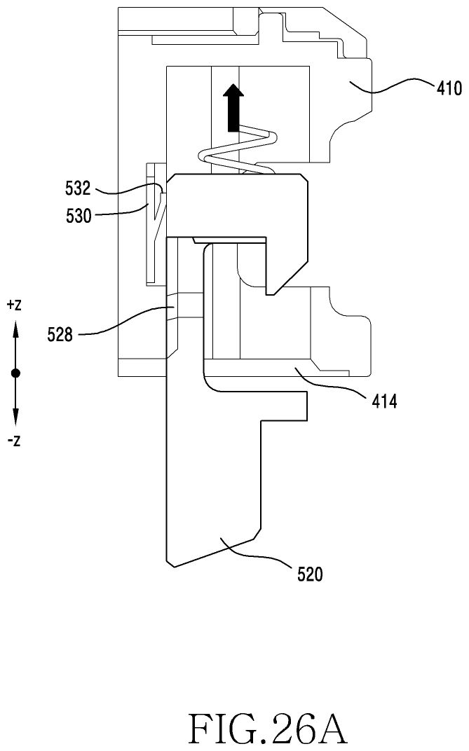

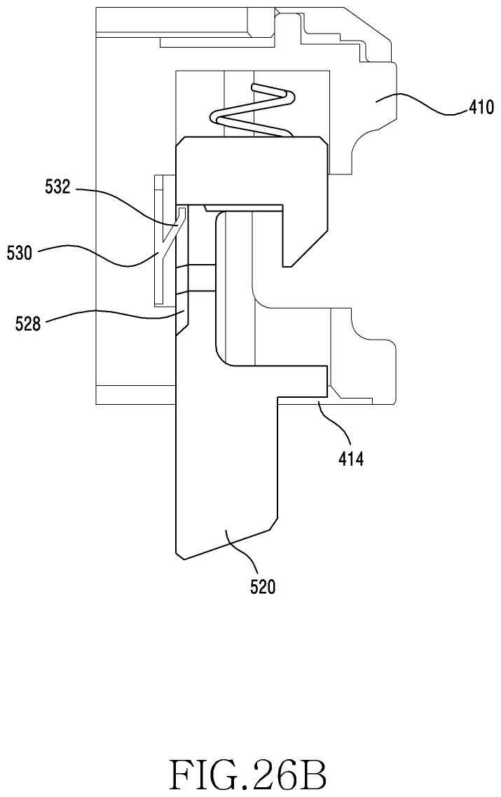

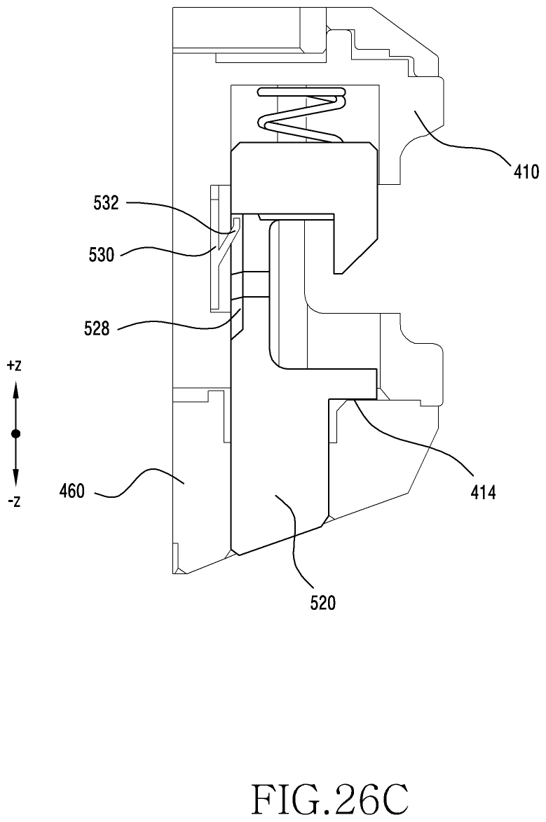

Referring to FIG. 25, the integral fastening member 520 of an embodiment may be inserted into the cavity portion 412 through the opening 414 of the housing 410. For example, the integral fastening member 520 may be inserted in an insertion direction toward the front direction (e.g., +z direction) of the electronic device 400 through the opening 414 of the housing 410, as indicated by the upward arrow in FIG. 25. For example, the groove 528 of the fastening member 520 may be supported by the hanging portion 532 of the locking member 530 disposed on the lateral wall 412-1 of the cavity portion 412. In addition, at least one spring 62 may be arranged in the at least one groove portion 526 of the fastening member 520. FIGS. 26A to 26C are drawings for explaining a process in which an integral fastening member is inserted into a cavity portion in which a locking member is arranged according to an embodiment.

Referring to FIG. 26A, the fastening member 520 of an embodiment may move in the front direction (e.g., +z direction) of the electronic device 400 through the opening 414 of the housing 410 and be inserted in the insertion direction into the housing 410. While the fastening member 520 is being inserted into the housing 410, the hanging portion 532 of the locking member 530 may be pushed toward the inside of the electronic device 400 by the fastening member 520 moving along the locking member 530 in the insertion direction. For example, FIG. 26A shows the hanging portion 532 disposed closer to the inner wall of the housing 410 than in FIG. 26B.

Referring to FIG. 26B, as the fastening member 520 of an embodiment is inserted deeper into the housing 410 than in FIG. 26A, the hanging portion 532 of the locking member 530 may be caught by the groove 528 of the fastening member 520. The hanging portion 532 of the locking member 530 may maintain contact with the groove 528 while exerting an elastic force on the groove 528 of the fastening member 520. Accordingly, the hanging portion 532 of the locking member 530 may support the fastening member 420 where the fastening member 520 is not separated to the outside of the housing 410 through the opening 414 (e.g., movement in a direction opposite to the insertion direction is restricted). According to an embodiment, since the locking member 530 prevents the fastening member 520 from being separated to the outside of the housing 410 through the opening 414, the fastening member 520 may be fixed within the housing 410 without using a separate bracket (e.g., 430).

Referring to FIG. 26C, after the hanging portion 532 of the locking member 530 of an embodiment is caught by the groove 528 of the fastening member 520, the back plate 460 may be disposed on a portion, which is not inserted into the housing 410, of the fastening member 520. The back plate 460 may be arranged in the housing 410 and cover a portion, which is not inserted into the housing 410, of the fastening member 520.

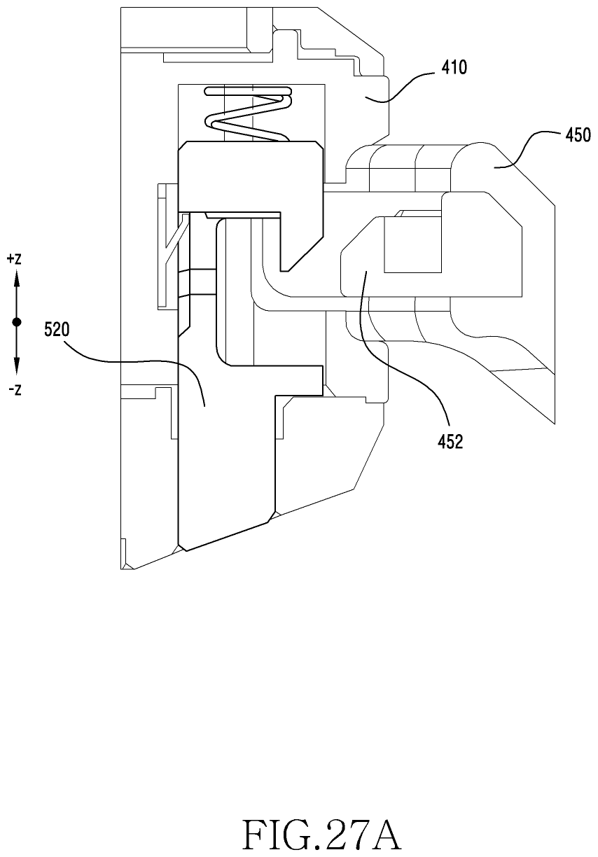

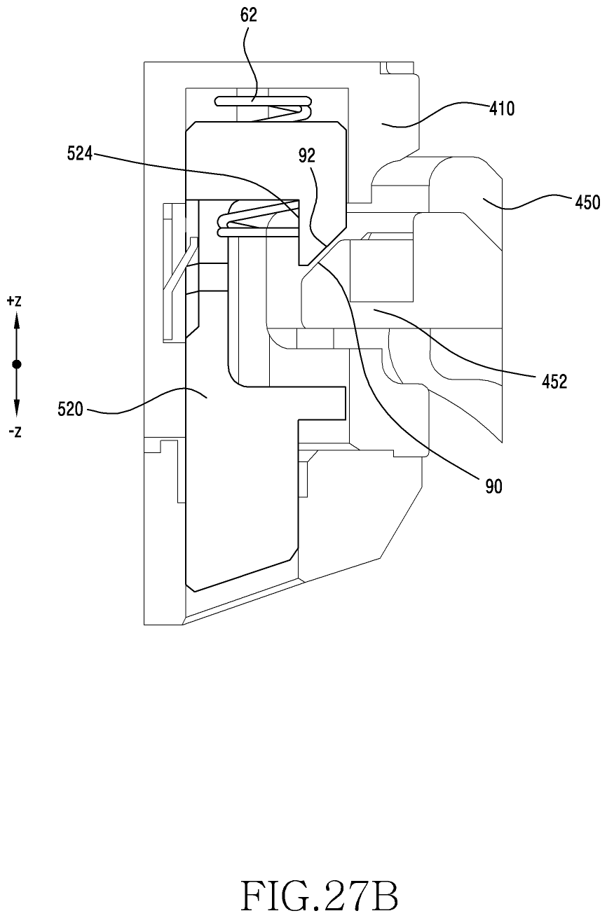

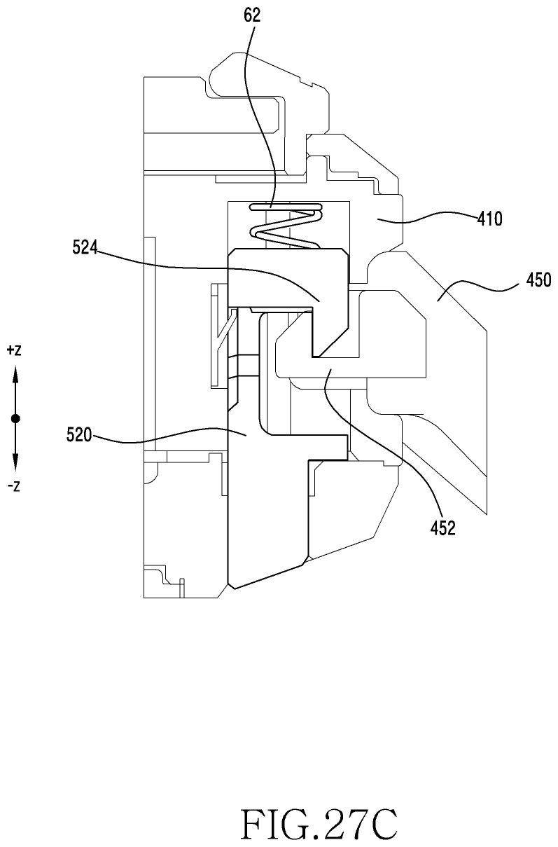

FIGS. 27A to 27C are drawings for explaining a process of attaching a strap to a fastening member according to an embodiment.

Referring to FIG. 27A, the attachment portion 452 of the strap 450 may move toward the fastening member 520 and be inserted into the inside of the housing 410, in a state where the fastening member 520 is arranged in the housing 410 of an embodiment.

Referring to FIG. 27B, an inclined face 92 of the hooking structure of the fastening member 520 arranged in the housing 410 of an embodiment may come into contact with an inclined face 90 of the attachment portion 452 of the strap 450. The inclined face 90 of the attachment portion 452 of the strap 450 may apply force to the inclined face 92 of the hooking structure of the hook portion 524 of the fastening member 520 arranged in the housing 410, and the fastening member 520 may move toward the front direction (e.g., +z direction) of the electronic device 400 by the force applied to the inclined face 92. For example, the inclined face 90 may apply, to the inclined face 92, a force greater than the elastic force of the spring 62, and move the fastening member 520 toward the front direction (e.g., +z direction) of the electronic device 400 and compress the spring 62.

Referring to FIG. 27C, as the attachment portion 452 of the strap 450 of an embodiment is inserted further into the housing 410, the attachment portion 452 of the strap 450 may be attached to the hook portion 524 of the fastening member 520 arranged within the housing 410. Here, where the inclined face 90 of the attachment portion 452 of the strap 450 moves further inside the cavity than the inclined face 92 of the hooking structure of the hook portion 524 of the fastening member 520 arranged in the housing 410, and the fastening member 520 may move toward the rear direction (e.g., −z direction) of the electronic device 400 by the biasing force applied from the spring 62 since the inclined face 90 applies a force less than the elastic force of the spring 62. When the fastening member 520 moves toward the rear direction (e.g., −z direction) of the electronic device 400 the spring 62 is uncompressed and the two hooks which respectively define the inclined faces 90 and 92, overlap each other in the x direction.

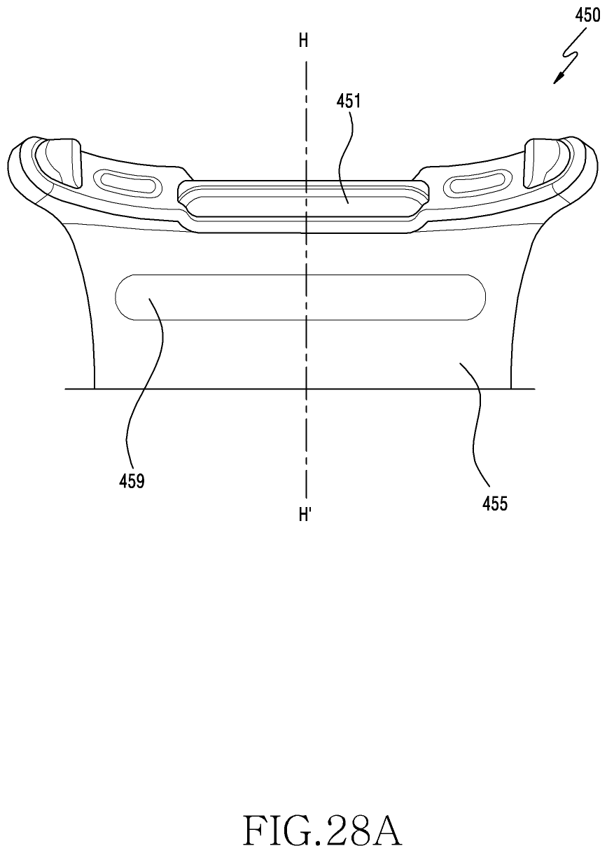

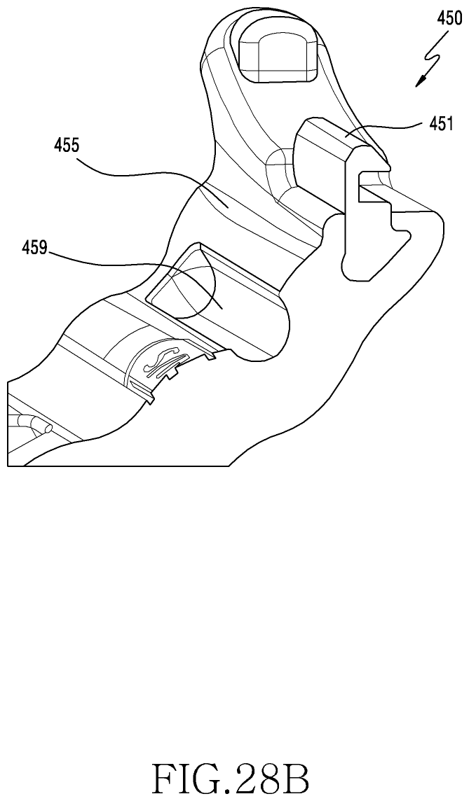

FIGS. 28A and 28B are drawings for explaining an air pocket formed in a strap according to an embodiment.

Referring to FIG. 28A, an air pocket 459 may be formed at a position adjacent to the strap adapter 451 in the strap body 455 of the strap 450 of an embodiment. The air pocket 459 may be formed along the strap adapter 451 at a position adjacent to the strap adapter 451 in the strap body 455.

FIG. 28B is a sectional view illustrating a section H-H′ of FIG. 28A.

Referring to FIG. 28B, the air pocket 459 of an embodiment may be formed in a sunken structure. Due to the air pocket 459, the thickness of a portion, where the air pocket 459 is formed, of the strap body 455 may be smaller than the thickness of other portions of the strap body 455. The air pocket 459 may be an empty space or an empty gap.

For example, the air pocket 459 may be formed in a portion, where bending is greater than a preset level, of the strap body 455 and increase the flexibility of the strap 450, and may allow the strap 450 to adhere to a body, such as the human body, when a user wears the electronic device on the human body.

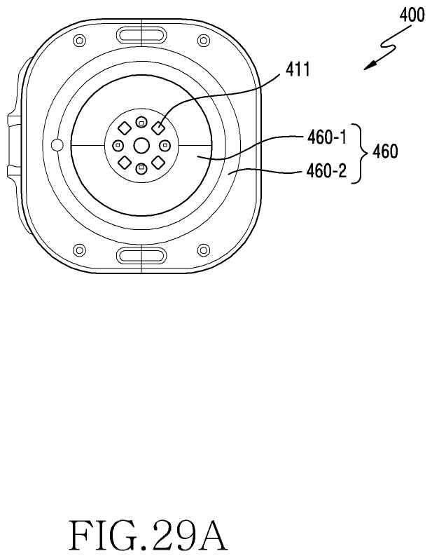

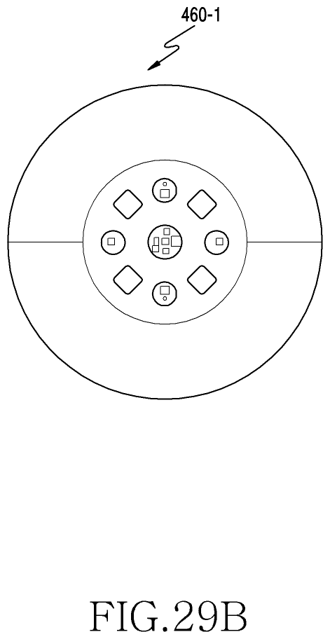

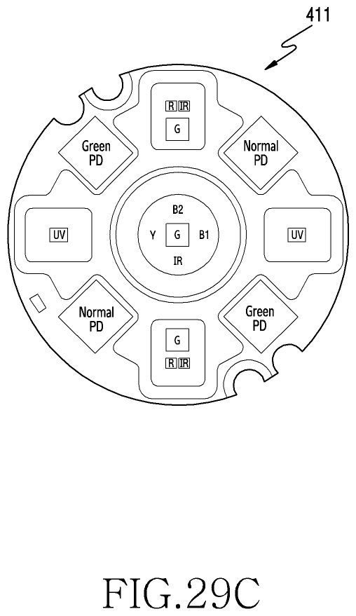

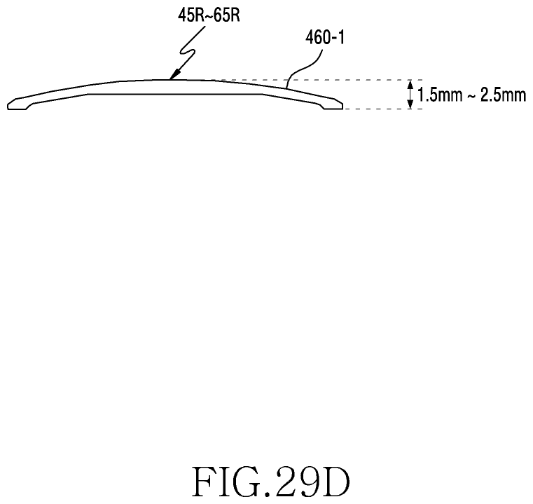

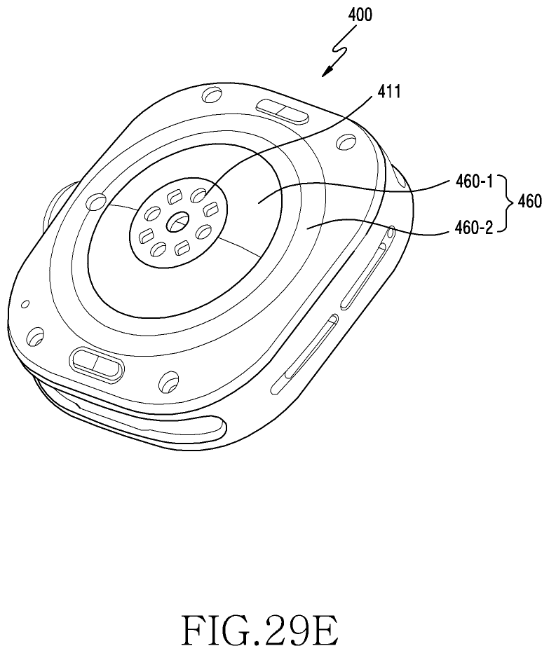

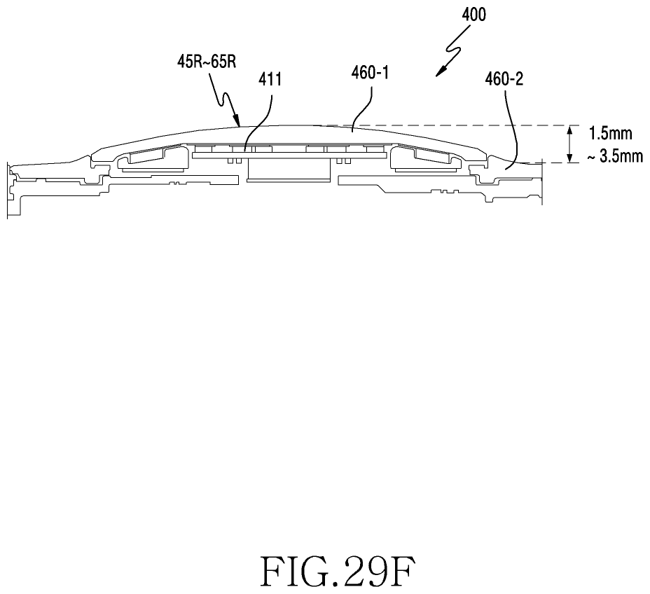

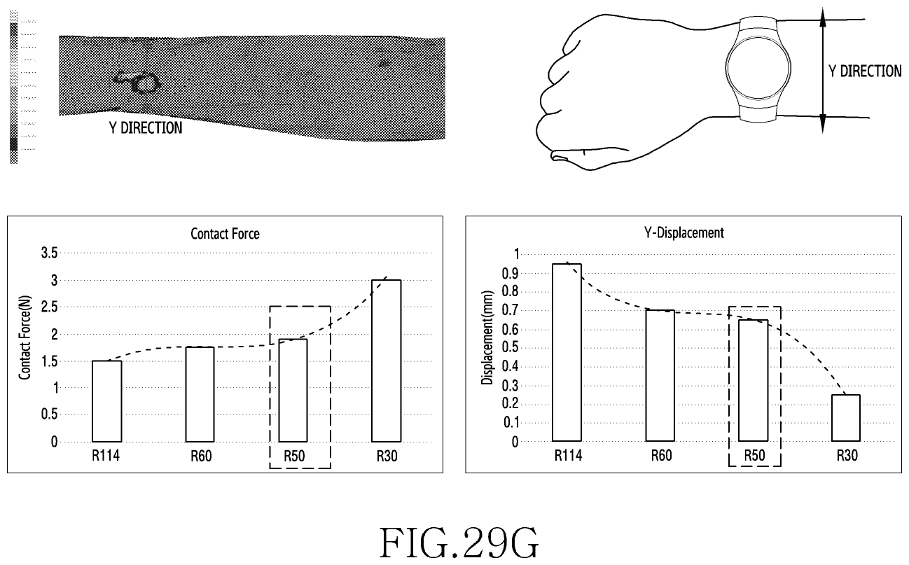

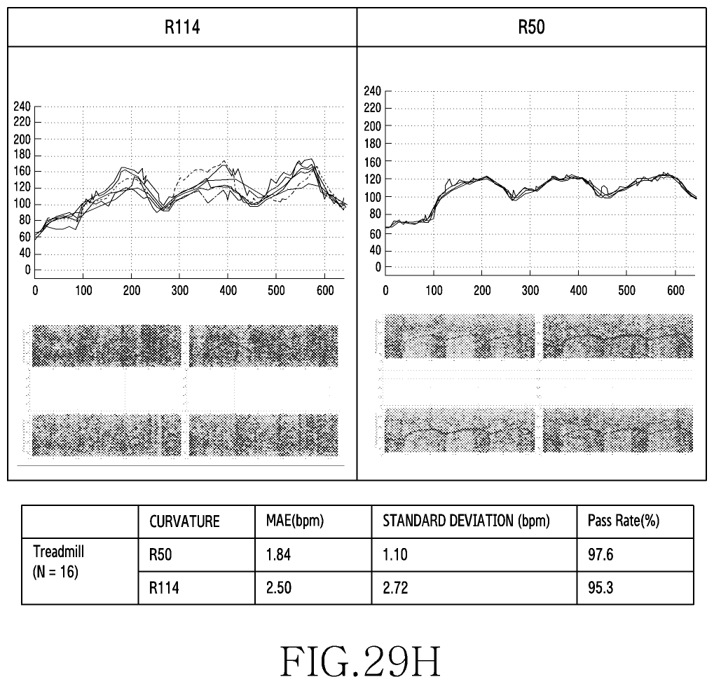

FIGS. 29A to 29C are drawings for explaining the protrusion of a back plate and a biometric sensor module disposed on a rear face of an electronic device.

FIGS. 29A, 29B and 29C are diagrams illustrating the back plate and the biometric sensor module disposed on the rear face of the electronic device according to an embodiment. FIG. 29D is a diagram illustrating a curvature of a first portion of the back plate of the electronic device according to an embodiment. FIGS. 29E and 29F are diagrams for explaining the back plate protruding at a predetermined curvature from the rear face of the electronic device according to an embodiment.

Referring to FIGS. 29A, 29B and 29C, the back plate 460 and the biometric sensor module 411 may be disposed on the rear face of the electronic device 400 of an embodiment. According to an embodiment, the biometric sensor module 411 may include light emitting diodes (LEDs) and photodiodes (PDs) for obtaining user's biometric information. For example, the biometric sensor module 411 may include LEDs and/or PDs for at least one of measurement of heart rate (HR), measurement for irregular heart rhythm notification (IHRN), measurement of electrocardiogram (ECG), measurement of blood pressure (BP), measurement for bioelectrical impedance analysis (BIA), or measurement of saturation of percutaneous oxygen (SpO2). In addition, for example, the biometric sensor module 411 may include LEDs and/or PDs for measuring at least one of an antioxidant level or advanced glycation end products.

For example, the LEDs may include thirteen LEDs. For example, the LEDs may include three Green LEDs, three IR LEDs, two Red LEDs, two UV LEDs, two Yellow LEDs, one Blue1 LED, and one Blue2 LED. However, the type and number of LEDs included in the LEDs are not limited thereto.

For example, the PDs may include four PDs. For example, the PDs may include two normal PDs and two green PDs. However, the type and number of PDs included in the PDs are not limited thereto.

According to an embodiment, the biometric sensor module 411 may be disposed on a PCB. In this case, for example, the PCB may be formed in a structure of six layers, and may have a thickness of about 0.38 T. Also, for example, the PCB may include an electrically erasable programmable read-only memory (EEPROM), and may support calibration for light intensity.

According to an embodiment, the back plate 460 may include a first portion 460-1 and a second portion 460-2. According to an embodiment, the first portion 460-1 of the back plate 460 may be arranged at a position corresponding to the biometric sensor module 411, and at least some of a plurality of LEDs and a plurality of PDs included in the biometric sensor module 411 may be shown from the outside of the electronic device 400 through the first portion 460-1 of the back plate 460. For example, the first portion 460-1 of the back plate 460 may be implemented by glass, but is not limited thereto.

According to an embodiment, the second portion 460-2 of the back plate 460 may be arranged to surround an edge of the first portion 460-1 of the back plate 460. In FIGS. 29A to 29F, it has been described that the back plate 460 has the first portion 460-1 and the second portion 460-2 as separate components, but is not limited thereto. The first portion 460-1 and the second portion 460-2 of the back plate 460 may also be formed as a single integral component.

Referring to FIGS. 29D and 29F, the first portion 460-1 of the back plate 460 of the electronic device 400 of an embodiment may be formed to have a predetermined curvature. The first portion 460-1 of the back plate 460 of the electronic device 400 may be formed to protrude more toward the rear face of the electronic device 400 than the second portion 460-2 of the back plate 460. For example, the back plate 460 may be formed to have a curvature range of about 45 R to about 65 R, and preferably may have a curvature of about 50 R. In addition, for example, the back plate 460 may protrude toward the rear face of the electronic device 400 by a protrusion level of about 1.5 millimeters (mm) to about 3.5 mm, and preferably may protrude by a protrusion level of about 2.5 mm.

FIG. 29G is a diagram illustrating an example in which an adherence force applied to the human body by the electronic device and the stability of the electronic device are ensured by a back plate of an electronic device having a curvature according to an embodiment.

Referring to FIG. 29G, when a curvature of the back plate 460 of the electronic device 400 of an embodiment is about 50 R, for example, the electronic device 400 may adhere to the user's human body with a force of about 1.5 newtons (N) to about 2.0 N and accordingly, the electronic device 400 may be stably worn on the user's human body without causing discomfort (e.g., pain, pressure) due to skin pressure to a user.

When a curvature of the back plate 460 of the electronic device 400 of an embodiment is about 50 R, for example, the electronic device 400 may have a relative displacement change of about 0.6 millimeter (mm) to about 0.7 mm in a Y direction and accordingly, the electronic device 400 may be more stably worn on the user's human body and thus the electronic device 400 may stably perform a sensing operation and obtain biometric information.

FIG. 29H is a diagram for explaining the deviation of biometric signals measured multiple times by an electronic device including a back plate having a curvature according to an embodiment.

Referring to FIG. 29H, when a curvature of the back plate 460 of the electronic device 400 is about 50 R, biometric signals (e.g., heart rate change) captured multiple times may have relatively small deviations. For example, when the curvature of the back plate 460 of the electronic device 400 is about 50 R, a mean average error (MAE) may be about 1.84 bpm, which is a lower value than when the curvature is about 114 R. In addition, for example, when the curvature of the back plate 460 of the electronic device 400 is about 50 R, a standard deviation may be about 1.10 bpm, which is a lower value than when the curvature is about 114 R. In addition, for example, when the curvature of the back plate 460 of the electronic device 400 is about 50 R, a pass rate may be about 97.6%, which is a higher value than when the curvature is about 114R. Accordingly, when a biometric signal is measured by the electronic device including the back plate having the curvature, the biometric signal may be measured more stably.

According to an embodiment, the back plate 460 may reduce a radius of curvature (R) of the first portion 460-1, and present a sufficient adherence force between the electronic device 400 and the user's human body when the electronic device 400 is worn on the user's human body. For example, when the strap 450 of the electronic device 400 is fastened to the electronic device 400 without a lug, the electronic device 400 may not present a sufficient adherence force to the user's human body compared to when the strap 450 is fastened by a lug of the housing 410. However, the electronic device 400 of an embodiment includes the back plate 460 having a predetermined curvature, whereby the electronic device 400 may present a sufficient adherence force to the user's human body without causing discomfort to a user, even when the strap 450 is located outside the housing 410.

In addition, for example, due to the protrusion of the first portion 460-1 of the back plate 460, the first portion 460-1 of the back plate 460 may dig further into and adhere closely to the user's skin. Accordingly, a void space between the LEDs and PDs of the biometric sensor module 411 and the user's human body may be eliminated, and the accuracy of biometric signal measurement of the electronic device 400 may be increased.

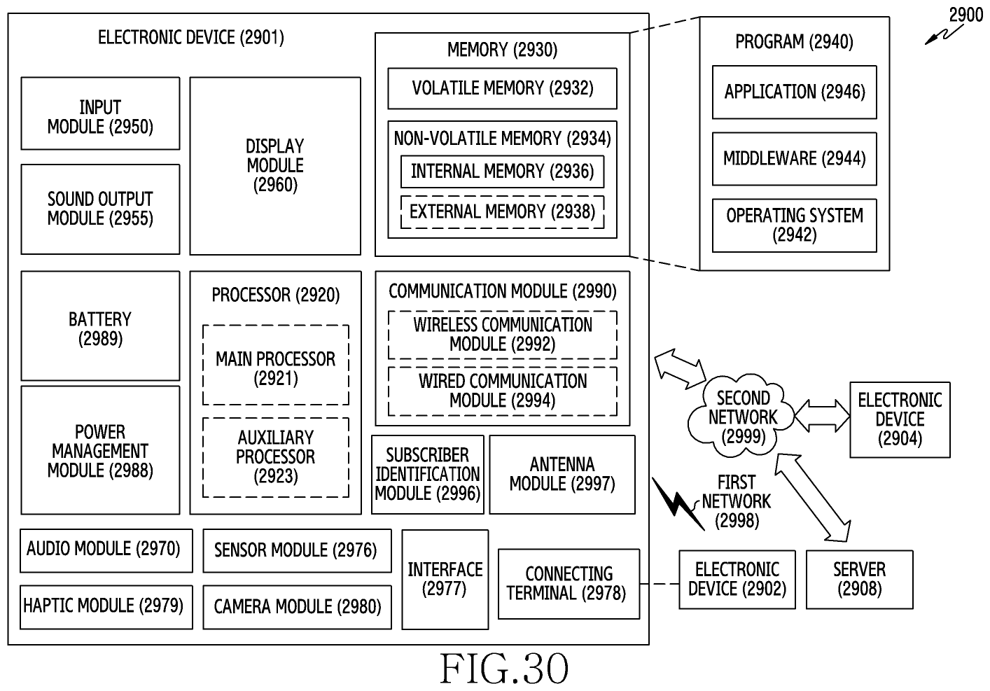

FIG. 30 is a block diagram illustrating an electronic device 2901 in a network environment 2900 according to various embodiments. Referring to FIG. 30, the electronic device 2901 in the network environment 2900 may communicate with an electronic device 2902 via a first network 2998 (e.g., a short-range wireless communication network), or at least one of an electronic device 2904 or a server 2908 via a second network 2999 (e.g., a long-range wireless communication network). According to an embodiment, the electronic device 2901 may communicate with the electronic device 2904 via the server 2908. According to an embodiment, the electronic device 2901 may include a processor 2920, memory 2930, an input module 2950, a sound output module 2955, a display module 2960, an audio module 2970, a sensor module 2976, an interface 2977, a connecting terminal 2978, a haptic module 2979, a camera module 2980, a power management module 2988, a battery 2989, a communication module 2990, a subscriber identification module (SIM) 2996, or an antenna module 2997. In some embodiments, at least one of the components (e.g., the connecting terminal 2978) may be omitted from the electronic device 2901, or one or more other components may be added in the electronic device 2901. In some embodiments, some of the components (e.g., the sensor module 2976, the camera module 2980, or the antenna module 2997) may be implemented as a single component (e.g., the display module 2960).

The processor 2920 may execute, for example, software (e.g., a program 2940) to control at least one other component (e.g., a hardware or software component) of the electronic device 2901 coupled with the processor 2920, and may perform various data processing or computation. According to one embodiment, as at least part of the data processing or computation, the processor 2920 may store a command or data received from another component (e.g., the sensor module 2976 or the communication module 2990) in volatile memory 2932, process the command or the data stored in the volatile memory 2932, and store resulting data in non-volatile memory 2934. According to an embodiment, the processor 2920 may include a main processor 2921 (e.g., a central processing unit (CPU) or an application processor (AP)), or an auxiliary processor 2923 (e.g., a graphics processing unit (GPU), a neural processing unit (NPU), an image signal processor (ISP), a sensor hub processor, or a communication processor (CP)) that is operable independently from, or in conjunction with, the main processor 2921. For example, when the electronic device 2901 includes the main processor 2921 and the auxiliary processor 2923, the auxiliary processor 2923 may be adapted to consume less power than the main processor 2921, or to be specific to a specified function. The auxiliary processor 2923 may be implemented as separate from, or as part of the main processor 2921.

The auxiliary processor 2923 may control at least some of functions or states related to at least one component (e.g., the display module 2960, the sensor module 2976, or the communication module 2990) among the components of the electronic device 2901, instead of the main processor 2921 while the main processor 2921 is in an inactive (e.g., sleep) state, or together with the main processor 2921 while the main processor 2921 is in an active state (e.g., executing an application). According to an embodiment, the auxiliary processor 2923 (e.g., an image signal processor or a communication processor) may be implemented as part of another component (e.g., the camera module 2980 or the communication module 2990) functionally related to the auxiliary processor 2923. According to an embodiment, the auxiliary processor 2923 (e.g., the neural processing unit) may include a hardware structure specified for artificial intelligence model processing. An artificial intelligence model may be generated by machine learning. Such learning may be performed, e.g., by the electronic device 2901 where the artificial intelligence is performed or via a separate server (e.g., the server 2908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 2930 may store various data used by at least one component (e.g., the processor 2920 or the sensor module 2976) of the electronic device 2901. The various data may include, for example, software (e.g., the program 2940) and input data or output data for a command related thereto. The memory 2930 may include the volatile memory 2932 or the non-volatile memory 2934.

The program 2940 may be stored in the memory 2930 as software, and may include, for example, an operating system (OS) 2942, middleware 2944, or an application 2946.

The input module 2950 may receive a command or data to be used by another component (e.g., the processor 2920) of the electronic device 2901, from the outside (e.g., a user) of the electronic device 2901. The input module 2950 may include, for example, a microphone, a mouse, a keyboard, a key (e.g., a button), or a digital pen (e.g., a stylus pen). The sound output module 2955 may output sound signals to the outside of the electronic device 2901. The sound output module 2955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 2960 may visually provide information to the outside (e.g., a user) of the electronic device 2901. The display module 2960 may include, for example, a display, a hologram device, or a projector and control circuitry to control a corresponding one of the display, hologram device, and projector. According to an embodiment, the display module 2960 may include a touch sensor adapted to detect a touch, or a pressure sensor adapted to measure the intensity of force incurred by the touch.

The audio module 2970 may convert a sound into an electrical signal and vice versa. According to an embodiment, the audio module 2970 may obtain the sound via the input module 2950, or output the sound via the sound output module 2955 or a headphone of an external electronic device (e.g., an electronic device 2902) directly (e.g., wiredly) or wirelessly coupled with the electronic device 2901.

The sensor module 2976 may detect an operational state (e.g., power or temperature) of the electronic device 2901 or an environmental state (e.g., a state of a user) external to the electronic device 2901, and then generate an electrical signal or data value corresponding to the detected state. According to an embodiment, the sensor module 2976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2977 may support one or more specified protocols to be used for the electronic device 2901 to be coupled with the external electronic device (e.g., the electronic device 2902) directly (e.g., wiredly) or wirelessly. According to an embodiment, the interface 2977 may include, for example, a high definition multimedia interface (HDMI), a universal serial bus (USB) interface, a secure digital (SD) card interface, or an audio interface.

A connecting terminal 2978 may include a connector via which the electronic device 2901 may be physically connected with the external electronic device (e.g., the electronic device 2902). According to an embodiment, the connecting terminal 2978 may include, for example, a HDMI connector, a USB connector, a SD card connector, or an audio connector (e.g., a headphone connector).

The haptic module 2979 may convert an electrical signal into a mechanical stimulus (e.g., a vibration or a movement) or electrical stimulus which may be recognized by a user via his tactile sensation or kinesthetic sensation. According to an embodiment, the haptic module 2979 may include, for example, a motor, a piezoelectric element, or an electric stimulator.

The camera module 2980 may capture a still image or moving images. According to an embodiment, the camera module 2980 may include one or more lenses, image sensors, image signal processors, or flashes.

The power management module 2988 may manage power supplied to the electronic device 2901. According to one embodiment, the power management module 2988 may be implemented as at least part of, for example, a power management integrated circuit (PMIC).

The battery 2989 may supply power to at least one component of the electronic device 2901. According to an embodiment, the battery 2989 may include, for example, a primary cell which is not rechargeable, a secondary cell which is rechargeable, or a fuel cell.

The communication module 2990 may support establishing a direct (e.g., wired) communication channel or a wireless communication channel between the electronic device 2901 and the external electronic device (e.g., the electronic device 2902, the electronic device 2904, or the server 2908) and performing communication via the established communication channel. The communication module 2990 may include one or more communication processors that are operable independently from the processor 2920 (e.g., the application processor (AP)) and supports a direct (e.g., wired) communication or a wireless communication. According to an embodiment, the communication module 2990 may include a wireless communication module 2992 (e.g., a cellular communication module, a short-range wireless communication module, or a global navigation satellite system (GNSS) communication module) or a wired communication module 2994 (e.g., a local area network (LAN) communication module or a power line communication (PLC) module). A corresponding one of these communication modules may communicate with the external electronic device via the first network 2998 (e.g., a short-range communication network, such as Bluetooth™, wireless-fidelity (Wi-Fi) direct, or infrared data association (IrDA)) or the second network 2999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 2992 may identify and authenticate the electronic device 2901 in a communication network, such as the first network 2998 or the second network 2999, using subscriber information (e.g., international mobile subscriber identity (IMSI)) stored in the subscriber identification module 2996.

The wireless communication module 2992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 2992 may support a high-frequency band (e.g., the mmWave band) to achieve, e.g., a high data transmission rate. The wireless communication module 2992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 2992 may support various requirements specified in the electronic device 2901, an external electronic device (e.g., the electronic device 2904), or a network system (e.g., the second network 2999). According to an embodiment, the wireless communication module 2992 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 2997 may transmit or receive a signal or power to or from the outside (e.g., the external electronic device) of the electronic device 2901. According to an embodiment, the antenna module 2997 may include an antenna including a radiating element composed of a conductive material or a conductive pattern formed in or on a substrate (e.g., a printed circuit board (PCB)). According to an embodiment, the antenna module 2997 may include a plurality of antennas (e.g., array antennas). In such a case, at least one antenna appropriate for a communication scheme used in the communication network, such as the first network 2998 or the second network 2999, may be selected, for example, by the communication module 2990 (e.g., the wireless communication module 2992) from the plurality of antennas. The signal or the power may then be transmitted or received between the communication module 2990 and the external electronic device via the selected at least one antenna. According to an embodiment, another component (e.g., a radio frequency integrated circuit (RFIC)) other than the radiating element may be additionally formed as part of the antenna module 2997.

According to various embodiments, the antenna module 2997 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 2901 and the external electronic device 2904 via the server 2908 coupled with the second network 2999. Each of the electronic devices 2902 or 2904 may be a device of a same type as, or a different type, from the electronic device 2901. According to an embodiment, all or some of operations to be executed at the electronic device 2901 may be executed at one or more of the external electronic devices 2902, 2904, or 2908. For example, if the electronic device 2901 should perform a function or a service automatically, or in response to a request from a user or another device, the electronic device 2901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 2901. The electronic device 2901 may provide the outcome, with or without further processing of the outcome, as at least part of a reply to the request. To that end, a cloud computing, distributed computing, mobile edge computing (MEC), or client-server computing technology may be used, for example. The electronic device 2901 may provide ultra low-latency services using, e.g., distributed computing or mobile edge computing. In another embodiment, the external electronic device 2904 may include an internet-of-things (IoT) device. The server 2908 may be an intelligent server using machine learning and/or a neural network. According to an embodiment, the external electronic device 2904 or the server 2908 may be included in the second network 2999. The electronic device 2901 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be understood that when an element is referred to as being related to another element such as “on” another element, it can be directly on the other element or intervening elements may be present therebetween. In contrast, when an element is referred to as being related to another element such as being “directly on” another element, there are no intervening elements present.

As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program #40) including one or more instructions that are stored in a storage medium (e.g., internal memory #36 or external memory #38) that is readable by a machine (e.g., the electronic device #01). For example, a processor (e.g., the processor #20) of the machine (e.g., the electronic device #01) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Where, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, the electronic device 2901 may correspond to the electronic device 100, the electronic device 200, and the electronic device 400.

A wearable electronic device 100, 300, or 400 of an embodiment may include a housing 410 including a first side, a second side at least partially spaced from the first side and including a portion facing the first side, and a lateral side enclosing a space between the first side and the second side, where each of the first side and the second side protrudes outwardly with respect to the lateral side and forms a cavity portion 412, and a hook member 420-2 arranged in the cavity portion 412 and configured to reciprocally move between the first side and the second side in a first direction toward the first side and a second direction toward the second side. The hook member 420-2 may include an attachment portion 10, and an ending portion of the attachment portion 10 may protrude in the direction toward the first side or the second side.

Here, the electronic device includes a housing in which a cavity is defined open to outside the housing, the cavity defined by a lateral side surface of the housing together with a first side wall (i.e., rear overhanging portion of the housing)_and a second side wall (i.e., front overhanging portion of the housing) each extended further than the lateral side surface and facing each other, and a fastening member coupled to the housing, the fastening member including a hook member which is reciprocally movable within the cavity along the lateral side surface, and a distal end of the hook member including a protruded attachment portion exposed to outside the housing and at which a strap of the wearable electronic device is detachably attached to the fastening member.

According to an embodiment, the wearable electronic device may further include a button member 420-1 arranged to have a first ending portion coupled to the hook member 420-2 and a second ending portion exposed to the outside of the wearable electronic device through an opening 414 formed in the first side, and the button member 420-1 may be configured to move the hook member 420-2 in the second direction through the first ending portion in response to an external force applied through the second ending portion. Here, the fastening member may further include a button member which is reciprocally moveable together with the hook member and coupled to the hook member at a first end of the button member, and a second end of the button member which is opposite to the first end, is exposed to outside the housing through an opening defined in the first side wall of the housing, and at which an external force is applied to the fastening member to move the hook member in a direction from the first side wall toward the second side wall.

According to an embodiment, the wearable electronic device may further include an elastic member arranged between the hook member 420-2 and the second side. Here, an elastic member may be between the hook member and the second side wall of the housing and provides a biasing force to the fastening member in a direction from the second side wall toward the first side wall.

According to an embodiment, the wearable electronic device may further include an elastic member arranged between the button member 420-2 and the hook member 420-2. Here, within the fastening member, an elastic member may be between the button member and the hook member.

According to an embodiment, the wearable electronic device may include a strap 450 including a strap adapter 451 including a strap attachment portion 452 fastened to the attachment portion 10 of the hook member 420-2 and a strap body 455 connected to the strap adapter 451, and the strap attachment portion 452 may be configured to receive at least a portion of the attachment portion 10 of the hook member 420-2. Here, the strap may further include a strap body at which the wearable electronic device is fastened to an external body (i.e., like a human body), and a strap connector which is connected to the strap body and at which the strap is detachably attached to the protruded attachment portion of the housing, the strap connector being configured to receive a portion of the protruded attachment portion in attachment of the strap to the housing.

According to an embodiment, the strap adapter 451 may include a plurality of protrusion guides 453, and the plurality of protrusion guides 453 of the strap adapter 451 may be inserted into a plurality of recesses 412-2 and 412-3 formed in the cavity portion 412. Here, the lateral side surface of the housing may include recesses defined therein which are open to the cavity, and the strap connector may include protrusion guides configured to be inserted into the recesses of the lateral side surface in the attachment of the strap to the housing.

According to an embodiment, the plurality of protrusion guides 453 of the strap adapter 451 may be positioned at both ends of the strap adapter 451, and may be formed in shapes corresponding to the recesses 412-2 and 412-3 formed in the cavity portion 412. Here, the fastening member may be provided between opposing ends of the lateral side surface along a length of the lateral side surface, and the protrusion guides of the strap connector may be provided corresponding to the opposing ends of the lateral side surface.

According to an embodiment, the strap adapter 451 may be formed in a shape corresponding to an inner face of the cavity portion 412. Here, inner surfaces of the first side wall and the second side wall together with the lateral side surface of the housing may define a shape of the cavity, and the strap connector may have a shape corresponding to the shape of the cavity.

According to an embodiment, the wearable electronic device may further include body magnets 441-1 and 441-2 arranged at positions corresponding to a portion of the cavity portion 412 in the housing 410, and strap magnets 454-1 and 454-2 disposed on the strap adapter 451, and the body magnets 441-1 and 441-2 and the strap magnets 454-1 and 454-2 may be positioned to face each other when the strap 450 is fastened to the housing 410. Here, body magnets may be in the housing and correspond to the cavity, and strap magnets may be on the strap connector. The wearable electronic device having the strap attached to the housing may include the body magnets respectively facing the strap magnet.

According to an embodiment, the body magnets 441-1 and 441-2 may be arranged between the button member 420-1 and the plurality of recesses 412-2 and 412-3 in the housing 410, and the strap magnets 454-1 and 454-2 may be arranged between the attachment portion 452 and the plurality of protrusion guides 453 in the strap adapter 451. Here, the body magnets may be respectively between the button member and a recess among the recesses, the strap connector may include an attachment portion configured to receive the portion of the protruded attachment portion in the attachment of the strap to the housing, and the strap magnets may be respectively between the attachment portion and a protrusion guide among the protrusion guides.

According to an embodiment, the body magnets 441-1 and 441-2 may be inserted into grooves formed in the housing 410, and the strap magnets 454-1 and 454-2 may be inserted into grooves formed in the strap adapter 451. Here, the housing may further include housing magnet grooves defined therein and in which the body magnets are respectively disposed, and the strap connector may further include strap magnet grooves defined therein and in which the strap magnets are respectively disposed.

According to an embodiment, the strap adapter 451 may include at least one first protrusion portion 51 or 52, and the at least one first protrusion portion 51 or 52 may be configured to compensate for a tolerance between the attachment portion 452 of the strap adapter 451 and the hook member 420-2 when the strap 450 is fastened to the housing 410. Here, the attachment of the strap to the housing may include the portion of the protruded attachment portion being received in the strap connector and a gap defined between the lateral side surface of the housing and an end portion of the strap connector which faces the lateral side surface, and the end portion of the strap connector may include a first protrusion corresponding to the gap defined between the end portion of the strap connector and the lateral side surface of the housing.

According to an embodiment, the strap adapter 451 may include at least one second protrusion portion 53, 54, 55, or 56, and the at least one second protrusion portion 53, 54, 55, or 56 may be configured to compensate for a tolerance between the strap body 455 and the cavity portion 412 of the housing 410 when the strap 450 is attached to the housing 410. Here, an inner surface of the first side wall and the second side wall together with the lateral side surface of the housing may define the cavity, the attachment of the strap to the housing may further includes a gap defined between the inner surface of the housing and a surface of an end portion of the strap connector which faces the inner surface, and the surface of the end portion of the strap connector may include a second protrusion corresponding to the gap defined between the inner surface of the housing and the surface of the strap connector which faces the inner surface.

According to an embodiment, the button member 420-1 and the hook member 420-2 may be formed integrally, and the integrally formed button member 420-1 and hook member 420-2 may be arranged in the cavity portion 412 through the opening 414 of the housing 410. Here, the button member and the hook member of the fastening member may be provided as a single, continuous body extended from the cavity and into the opening of the housing.

According to an embodiment, the wearable electronic device may further include a locking member 530 arranged in a position corresponding to the hook member 420-2 on one face of the cavity portion 412, and when the integrally formed button member 420-1 and hook member 420-2 are arranged in the cavity portion 412, a hanging portion 532 of the locking member 530 may support a portion of a groove 528 formed within the hook member 420-2. Here, a locking member may be in the cavity of the housing and configured to be engaged with the hook member of the fastening member. The single, continuous body may define a groove within the hook member at which the locking member engages the fastening member, and the groove which is engaged with the locking member may restrict movement of the fastening member in a direction from the second side wall toward the first side wall.

An electronic device 100, 300, or 400 of an embodiment may include a housing 410 including a cavity portion 412 formed toward a side direction of the electronic device, a hook member 420-2 arranged within the cavity portion 412 and protruding toward the side direction of the electronic device, a button member 420-1 configured to move the hook member 420-2 toward a front direction of the electronic device by applying force to the hook member 420-2 toward the front direction of the electronic device, and a strap 450 fastened to the hook portion 524. The strap 450 may include a strap body 455, and a strap adapter 451 including an attachment portion 452 and a plurality of protrusion guides 453, and positioned at one side of the strap body 455 and fastened to the hook portion 524. The attachment portion 452 of the strap adapter 451 may be fastened to the hook member 420-2. The plurality of protrusion guides 453 of the strap adapter 451 may be inserted into a plurality of recesses 412-2 and 412-3 formed in the cavity portion 412 and prevent the movement of the strap 450 fastened to the housing 410.

In addition, according to an embodiment, the button member 420-1 may be assembled to the hook member 420-2 arranged in the cavity portion 412, through an opening 414 formed in a rear face of the housing 410.

In addition, according to an embodiment, at least one spring may be arranged in at least one groove formed in the hook member 420-2, whereby the at least one spring may be arranged between the hook member 420-2 and the cavity portion 412.

In addition, according to an embodiment, a spring may be arranged in at least one groove formed in the hook member 420-2, whereby the spring may be arranged between the button member 420-1 and the hook member 420-2.

In addition, according to an embodiment, the plurality of protrusion guides 453 of the strap adapter 451 may be positioned at both ends of the strap adapter 451 and may be formed in shapes corresponding to the recesses 412-2 and 412-3 formed in the cavity portion 412.

According to an embodiment, the strap adapter 451 may be formed in a shape corresponding to an inner face of the cavity portion 412.

According to an embodiment, the electronic device may further include body magnets 441-1 and 441-2 arranged at positions corresponding to a portion of the cavity portion 412 in the housing 410, and strap magnets 454-1 and 454-2 disposed on the strap adapter 451. The body magnets 441-1 and 441-2 and the strap magnets 454-1 and 454-2 may be positioned to face each other when the strap is fastened to the housing 410.

In addition, according to an embodiment, the body magnets 441-1 and 441-2 may be arranged between the button member 420-1 and the plurality of recesses 412-2 and 412-3 in the housing 410, and the strap magnets 454-1 and 454-2 may be arranged between the attachment portion 452 and the plurality of protrusion guides 453 in the strap adapter 451.

In addition, according to an embodiment, the body magnets 441-1 and 441-2 may be inserted into grooves formed in the housing 410, and the strap magnets 454-1 and 454-2 may be inserted into grooves formed in the strap adapter 451.

In addition, according to an embodiment, a portion of the attachment portion 452 of the strap adaptor 351 may protrude from one face of the strap adaptor 451.

In addition, according to an embodiment, the attachment portion 452 of the strap adaptor 351 may be formed not to protrude from one side of the strap adaptor 451.

In addition, according to an embodiment, the strap adapter 451 may include at least one first protrusion portion 51 or 52, and the at least one first protrusion portion 51 or 52 may be configured to compensate for a tolerance between the attachment portion 452 of the strap adapter 451 and the hook member 420-2 when the strap 450 is fastened to the housing 410.

In addition, according to an embodiment, the strap adapter 451 may include at least one second protrusion portion 53, 54, 55, or 56, and the at least one second protrusion portion 53, 54, 55, or 56 may be configured to compensate for a tolerance between the strap body 455 and the cavity portion 412 of the housing 410 when the strap 450 is attached to the housing 410.

In addition, according to an embodiment, the button member 420-1 and the hook member 420-2 may be formed integrally, and the integrally formed button member 420-1 and hook member 420-2 may be arranged in the cavity portion 412 through the opening 414 formed in a rear face of the housing 410.

In addition, according to an embodiment, the electronic device may further include a locking member 530 arranged in a position corresponding to the hook member 420-2 on one face of the cavity portion 412, and when the integrally formed button member 420-1 and hook member 420-2 are arranged in the cavity portion 412, a hanging portion 532 of the locking member 530 may support a portion of a groove 528 formed within the hook member 420-2 and prevent the integrally formed button member 420-1 and hook member 420-2 from being separated to the outside of the housing through the opening 414.

An electronic device 100, 300, or 400 of an embodiment may include a housing 410 including a cavity portion 412 formed toward a side direction of the electronic device, a fastening member 520 including a hook portion 524 arranged within the cavity portion 412 and protruding toward the side direction of the electronic device, and a button portion 522 extending from the hook portion 524 toward a rear direction of the electronic device, and a strap 450 including a strap body 455, and a strap adapter 451 positioned at one side of the strap body 455 and fastened to the hook portion 524. The strap adapter 451 may include an attachment portion 452 and a plurality of protrusion guides 453. The attachment portion 452 of the strap adapter 451 may be fastened to the hook portion 524. The plurality of protrusion guides 453 of the strap adapter 451 may be inserted into a plurality of recesses 412-2 and 412-3 formed in the cavity portion 412 and prevent the movement of the strap 450 fastened to the housing 410.

Here, the electronic device include a housing in which a cavity is defined open to outside the housing in a side direction of the electronic device and in which recesses are defined open to the cavity, a fastening member moveably coupled to the housing and at which a strap of the electronic device is detachably attached to the housing, the fastening member including a hook portion reciprocally moveable between a front direction and a rear direction of the electronic device, within the cavity, and protruding in the side direction of the electronic device, and a button portion extending from the hook portion in the rear direction of the electronic device and reciprocally moveable together with the hook portion, and the strap including a strap adapter at an end of the strap and configured to be detachably attached to the hook portion of the fastening member, the strap adapter including an attachment portion at which the strap adapter is detachably attached to the hook portion, and protrusion guides adjacent to the attachment portion and configured to be respectively inserted into the recesses of the housing, and a strap body extended from the strap adapter

In addition, according to an embodiment, the fastening member 520 may be arranged in the cavity portion 412 through the opening 414 formed in a rear face of the housing 410. Here, an opening may be further defined in the housing, the opening exposing the cavity to outside the housing, in the rear direction of the electronic device, and the fastening member may extend through the opening of the housing to be exposed to outside the housing, in the rear direction of the electronic device.

In addition, according to an embodiment, the electronic device may further include a locking member 530 arranged at a position corresponding to the hook portion 420-2 on one face of the cavity portion 412. Here, a locking member may be in the cavity of the housing and corresponding to the hook portion of the fastening member.

In addition, according to an embodiment, when the fastening member 520 is arranged in the cavity portion 412, a hanging portion 532 of the locking member 530 may support a portion of a groove 528 formed within the hook member 420-2 and prevent the integrally formed button member 420-1 and hook member 420-2 from being separated to the outside of the housing through the opening 414. Here, a groove may be defined in the fastening member at which a hanging portion of the locking member engages the fastening member, and the groove which is engaged with the locking member at the hanging portion thereof, may restrict movement of the fastening member in the rear direction of the electronic device.

In addition, according to an embodiment, the electronic device may further include body magnets 441-1 and 441-2 arranged at positions corresponding to a portion of the cavity portion 412 in the housing 410, and strap magnets 454-1 and 454-2 disposed on the strap adapter 451. When the strap 450 is fastened to the housing 410, the body magnets 441-1 and 441-2 and the strap magnets 454-1 and 454-2 may be positioned to face each other. Here, body magnets may be in the housing and correspond to the cavity, and strap magnets may be on the strap adapter. The electronic device having the strap attached to the housing may include the body magnet respectively facing the strap magnets.

A wearable electronic device includes a housing in which a cavity is defined open to outside the housing, an attachment structure (like 420 together with 452) of the wearable electronic device, a strap which is detachably attached to the housing by the attachment structure, and the attachment structure including a fastening member which is within the cavity of the housing, exposed to outside the housing by the cavity, and reciprocally movable within the cavity along a thickness direction of the housing, and a strap connector which is at an end of the strap and is detachably attachable to the fastening member. The wearable electronic device having the strap attached to the housing includes the strap connector disposed within the cavity and attached to the fastening member at a position within the cavity (like in FIGS. 12B or 27B, for example).

A wearable electronic device includes a housing in which a cavity is defined open to outside the housing in both a side direction of the wearable electronic device and in a length direction of the cavity, an attachment structure of the wearable electronic device, a strap which is detachably attached to the housing by the attachment structure, and the attachment structure including a fastening member which is within the cavity of the housing and reciprocally movable within the cavity along a thickness direction of the housing, the fastening member including a hook member having a length extended along the length direction of the cavity, and a strap connector which is at the end of the strap, detachably attachable to the fastening member, and having a length extended along the length direction of the cavity. The wearable electronic device having the strap attached to the housing includes a first attachment area within the cavity at which the hook member overlaps the strap connector in the thickness direction and in the side direction, along the length of the hook.

Recesses may be further defined in the housing which are open to the cavity, the recesses respectively disposed at opposing sides of the hook member along the length thereof, the strap connector may include protrusion guides respectively at opposing ends of the strap connector along the length thereof, and the wearable electronic device having the strap attached to the housing may further include a second attachment area within the cavity at which the protrusion guides are respectively extended into the recesses of the housing and overlap the housing in the length direction of the cavity.

In the specific embodiments of the disclosure described above, components included in the disclosure have been expressed singularly or plurally according to the specific embodiments presented. However, the expression of singular or plural is selected appropriately for the presented situation for the convenience of explanation, and the disclosure is not limited to singular or plural components, and even a component expressed plurally may be constructed singularly or even a component expressed singularly may be constructed plurally.

In addition, in the disclosure, “including at least one of a, b, or c” may mean “including only a, including only b, including only c, or including a combination of two or more (including a and b, including b and c, including a and c, or including all of a, b, and c)”.

Meantime, in the detailed description of the disclosure, specific embodiments have been described, but it is undoubted that various modifications are possible without departing from the scope of the disclosure. Therefore, the scope of the disclosure should not be limited to the described embodiments, but should be defined not only by the scope of the claims described later, but also by those equivalent to the scope of the claims.

In the disclosure, the term “when” will be understood to mean “upon”, “in response to determining”, or “in response to detecting”, depending on context. Similarly, “when it is determined that ˜” or “when [the condition or event mentioned] is detected” will be understood to selectively mean “upon determining”, “in response to determining”, “upon detecting [the condition or event mentioned]”, or “in response to detecting [the condition or event mentioned]”.

Although the embodiments have been described by way of limited examples and drawings, those skilled in the art will appreciate that various modifications and variations are possible from the above description. For example, a suitable result may be achieved even if the described techniques are performed in a different order than the described method, and/or even if components of the described systems, structures, devices, circuits, etc. are coupled or combined in a different form than the described method or are replaced or substituted by other components or equivalents.

What is claimed is:

1. A wearable electronic device (100, 300, or 400) comprising:
a housing (410) comprising a first side, a second side at least partially spaced from the first side and comprising a portion facing the first side, and a lateral side enclosing a space between the first side and the second side, wherein each of the first side and the second side protrudes outwardly with respect to the lateral side and forms a cavity portion (412); and
a hook member (420-2) arranged in the cavity portion (412) and configured to reciprocally move between the first side and the second side in a first direction toward the first side and a second direction toward the second side, wherein the hook member comprises an attachment portion (10), and an ending portion of the attachment portion (10) protrudes in the direction toward the first side or the second side.

2. The wearable electronic device of claim 1, further comprising a button member (420-1) arranged to have a first ending portion coupled to the hook member (420-2) and a second ending portion exposed to the outside of the wearable electronic device through an opening (414) formed in the first side,
wherein the button member is configured to move the hook member in the second direction through the first ending portion in response to an external force applied through the second ending portion.

3. The wearable electronic device of claim 2, further comprising an elastic member arranged between the hook member (420-2) and the second side.

4. The wearable electronic device of claim 2, further comprising an elastic member arranged between the button member and the hook member.

5. The wearable electronic device of claim 1, comprising a strap (450) comprising a strap adapter (451) comprising a strap attachment portion (452) fastened to the attachment portion (10) of the hook member and a strap body (455) connected to the strap adapter,
wherein the strap attachment portion (452) is configured to receive at least a portion of the attachment portion (10) of the hook member.

6. The wearable electronic device of claim 5, wherein
the strap adapter (451) comprises a plurality of protrusion guides (453), and
the plurality of protrusion guides (453) of the strap adapter (451) are inserted into a plurality of recesses (412-2 and 412-3) formed in the cavity portion (412).

7. The wearable electronic device of claim 6, wherein the plurality of protrusion guides (453) of the strap adapter (451) are positioned at both ends of the strap adapter (451) and are formed in shapes corresponding to the recesses (412-2 and 412-3) formed in the cavity portion (412).

8. The wearable electronic device of claim 6, wherein the strap adapter (451) is formed in a shape corresponding to an inner face of the cavity portion (412).

9. The wearable electronic device of claim 8, further comprising:
body magnets (441-1 and 441-2) arranged at positions corresponding to a portion of the cavity portion (412) in the housing (410); and
strap magnets (454-1 and 454-2) disposed on the strap adapter (451),
wherein the body magnets (441-1 and 441-2) and the strap magnets (454-1 and 454-2) are positioned to face each other when the strap is fastened to the housing (410).

10. The wearable electronic device of claim 9, wherein
the body magnets (441-1 and 441-2) are arranged between the button member (420-1) and the plurality of recesses (412-2 and 412-3) in the housing (410), and
the strap magnets (454-1 and 454-2) are arranged between the attachment portion (452) and the plurality of protrusion guides (453) in the strap adapter (451).

11. The wearable electronic device of claim 10, wherein
the body magnets (441-1 and 441-2) are inserted into grooves formed in the housing (410), and
the strap magnets (454-1 and 454-2) are inserted into grooves formed in the strap adapter (451).

12. The wearable electronic device of claim 5, wherein
the strap adapter (451) comprises at least one first protrusion portion (51 or 52), and
the at least one first protrusion portion (51 or 52) is configured to compensate for a tolerance between the attachment portion (452) of the strap adapter (451) and the hook member (420-2) when the strap (450) is fastened to the housing (410).

13. The wearable electronic device of claim 5, wherein
the strap adapter (451) comprises at least one second protrusion portion (53, 54, 55, or 56), and
the at least one second protrusion portion (53, 54, 55, or 56) is configured to compensate for a tolerance between the strap body (455) and the cavity portion (412) of the housing (410) when the strap (450) is attached to the housing (410).

14. The wearable electronic device of claim 1, wherein
the button member (420-1) and the hook member (420-2) are formed integrally, and
the integrally formed button member (420-1) and hook member (420-2) are arranged in the cavity portion (412) through the opening (414) of the housing (410).

15. The wearable electronic device of claim 14, further comprising a locking member (530) arranged in a position corresponding to the hook member (420-2) on one face of the cavity portion (412),
wherein when the integrally formed button member (420-1) and hook member (420-2) are arranged in the cavity portion (412), a hanging portion (532) of the locking member (530) supports a portion of a groove (528) formed within the hook member (420-2) and prevents the integrally formed button member (420-1) and hook member (420-2) from being separated to the outside of the housing through the opening (414).

16. An electronic device (100, 300, or 400) comprising:
a housing (410) comprising a cavity portion (412) formed toward a side direction of the electronic device;
a fastening member (520) comprising a hook portion (524) arranged within the cavity portion (412) and protruding toward the side direction of the electronic device, and a button portion (522) extending from the hook portion (524) toward a rear direction of the electronic device; and
a strap (450) comprising a strap body (455), and a strap adapter (451) positioned at one side of the strap body (455) and fastened to the hook portion (524),
wherein
the strap adapter (451) comprises an attachment portion (452) and a plurality of protrusion guides (453),
the attachment portion (452) of the strap adapter (451) is fastened to the hook portion (524), and
the plurality of protrusion guides (453) of the strap adapter (451) are inserted into a plurality of recesses (412-2 and 412-3) formed in the cavity portion (412).

17. The electronic device of claim 16, wherein the fastening member (520) is arranged in the cavity portion (412) through the opening (414) of the housing (410).

18. The electronic device of claim 16, further comprising a locking member (530) arranged at a position corresponding to the hook portion (420-2) on one face of the cavity portion (412).

19. The electronic device of claim 18, wherein when the fastening member (520) is arranged in the cavity portion (412), a hanging portion (532) of the locking member (530) supports a portion of a groove (528) formed within the hook member (420-2).

20. A wearable electronic device comprising:
a housing in which a cavity is defined open to outside the housing, the cavity defined by a lateral side surface of the housing together with a first side wall and a second side wall each extended further than the lateral side surface and facing each other; and
a fastening member coupled to the housing, the fastening member comprising:
a hook member which is reciprocally movable within the cavity along the lateral side surface, and
a distal end of the hook member comprising a protruded attachment portion exposed to outside the housing and at which a strap of the wearable electronic device is detachably attached to the fastening member.
